(19) United States
(12) Patent Application Publication
(10) Pub. No.: US 2018/0025478 A1
(43) Pub. Date: Jan. 25, 2018

(54) ELECTRONIC DEVICE FOR PROCESSING IMAGE

(71) Applicant: Samsung Electronics Co., Ltd., Suwon-si (KR)

(72) Inventors: Ki Huk LEE, Suwon-si (KR); Kwang Young KIM, Yongin-si (KR); Kwang Tai KIM, Suwon-si (KR); Soo Hyung KIM, Hwaseong-si (KR); Sung Hyuk SHIN, Seongnam-si (KR); Dong Hyun YEOM, Bucheon-si (KR); In Jong RHEE, Seongnam-si (KR); Jung Eun LEE, Suwon-si (KR); Cheol Ho CHEONG, Seoul (KR); Jihwan CHOE, Bucheon-si (KR); Ho Chul HWANG, Yongin-si (KR)

(21) Appl. No.: 15/657,750

(22) Filed: Jul. 24, 2017

(30) Foreign Application Priority Data
Jul. 25, 2016 (KR) 10-2016-0094003

(51) Int. Cl. G06T 5/50; H04N 5/247; H04N 7/01

(52) U.S. Cl. CPC G06T 5/50; H04N 7/0127; H04N 5/247; G06T 2207/20004; G06T 3/40

(57) ABSTRACT

An electronic device for processing one or more images is provided. The electronic device includes a communication circuit that receives images including at least a part of original images obtained by a plurality of cameras of an external device, a memory that stores the images, and at least one processor that is electrically connected with the communication circuit and the memory. The at least one processor is configured to obtain information associated with at least part of the external device, the electronic device, or the plurality of images, and to perform at least one of a plurality of processes on part of each of the images, or a part of the plurality of processes on the images, based on the information associated with the at least part of the external device, the electronic device, or the images.

### CROSS-REFERENCE TO RELATED APPLICATION(S)

This application claims the benefit under 35 U.S.C. §119(a) of a Korean patent application filed on Jul. 25, 2016 in the Korean Intellectual Property Office and assigned Serial number 10-2016-0094003, the entire disclosure of which is hereby incorporated by reference.

### TECHNICAL FIELD

The present disclosure relates to a technology that processes an image in an electronic device.

### BACKGROUND

With the development of electronic technologies, various types of electronic products are being developed and distributed. Nowadays, a concern for a wearable electronic device mountable on a body of a user is increasing. In particular, a head-mounted device mountable on a head of the user, digital glasses, and the like are being actively developed.

A concern for a multi-view image is increasing according to the development of the above-described head-mounted device. The multi-view image means an image in which a viewpoint at which an image is displayed is variously changed. For example, the multi-view image may include an immersive video, an omnidirectional video, or a virtual reality (VR) video including a three-dimensional (3D) object. The multi-view image may be played back by electronic devices, such as a smartphone, a tablet personal computer (PC), a desktop, and the like, as well as the head-mounted device. Also, a concern for a device for capturing a multi-view image is increasing nowadays.

The number of operations necessary to process the multi-view image may be more than that necessary to process an image according to the related art. As such, a multi-view image capturing device may consume a lot of power. As power consumption of the capturing device increases, excessive heat is generated in the capturing device.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a capturing device capable of reducing operations to be performed for image processing and an electronic device connected with the capturing device.

In accordance with an aspect of the present disclosure, an electronic device is provided. The electronic device may include a communication circuit that receives a plurality of images including at least a part of original images obtained by a plurality of cameras of an external device, a memory that stores the received plurality of images, and at least one processor that is electrically connected with the communication circuit and the memory. The processor may be configured to obtain information associated with at least part of the external device, the electronic device, or the plurality of images, and based on the obtained information, at least part of the external device, the electronic device, or the plurality of images, at least one of perform a plurality of processes on a part of each of the plurality of images, or perform a part of the plurality of processes on at least part of the plurality of images.

In accordance with another aspect of the present disclosure, an electronic device is provided. The electronic device may include a plurality of cameras that are disposed to face different directions, a communication circuit that communicates with an external device, and at least one processor that is electrically connected with the plurality of cameras and the communication circuit. The processor may be configured to obtain a plurality of images by respectively using the plurality of cameras, to obtain information associated with at least a part of the external device, the electronic device, or the plurality of images, from the external device or within the electronic device, and based on the obtained information, at least one of perform a plurality of processes on a part of each of the plurality of images, or perform a part of the plurality of processes on at least part of each of the plurality of images.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates an operating environment of a first electronic device and a second electronic device according to an embodiment of the present disclosure;

FIG. 2 is a block diagram illustrating a configuration of the first electronic device according to an embodiment of the present disclosure;

FIG. 3 is a block diagram illustrating a configuration of the second electronic device according to an embodiment of the present disclosure;

FIG. 4 is a block diagram illustrating a configuration of the first electronic device and the second electronic device according to an embodiment of the present disclosure;

FIG. 5 is a flowchart for describing an image processing method of the first electronic device according to an embodiment of the present disclosure;

FIG. 6 is a flowchart for describing an image processing method of the second electronic device according to an embodiment of the present disclosure;

FIGS. 7A and 7B illustrate images obtained by the first electronic device according to various embodiments of the present disclosure;

FIG. 8 illustrates an image processed by the first electronic device and the second electronic device according to an embodiment of the present disclosure;

FIG. 9 is a flowchart for describing an image processing method of the first electronic device according to an embodiment of the present disclosure;

FIG. 10 is a flowchart for describing the image processing method of the first electronic device according to an embodiment;

FIG. 11 illustrates the electronic device in a network environment according to various embodiments of the present disclosure;

FIG. 12 illustrates a block diagram of the electronic device according to various embodiments of the present disclosure; and

FIG. 13 illustrates a block diagram of a program module according to various embodiments of the present disclosure.

Throughout the drawings, it should be noted that like reference numbers are used to depict the same or similar elements, features, and structures.

### DETAILED DESCRIPTION

The following description with reference to accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In this disclosure, the expressions “have”, “may have”, “include” and “comprise”, or “may include” and “may comprise” used herein indicate existence of corresponding features (e.g., elements such as numeric values, functions, operations, or components) but do not exclude presence of additional features.

In this disclosure, the expressions “A or B”, “at least one of A or/and B”, or “one or more of A or/and B”, and the like may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included.

The terms, such as “first”, “second”, and the like used in this disclosure may be used to refer to various elements regardless of the order and/or the priority and to distinguish the relevant elements from other elements, but do not limit the elements. For example, “a first user device” and “a second user device” indicate different user devices regardless of the order or priority. For example, without departing the scope of the present disclosure, a first element may be referred to as a second element, and similarly, a second element may be referred to as a first element.

It will be understood that when an element (e.g., a first element) is referred to as being “(operatively or communicatively) coupled with/to” or “connected to” another element (e.g., a second element), it may be directly coupled with/to or connected to the other element or an intervening element (e.g., a third element) may be present. In contrast, when an element (e.g., a first element) is referred to as being “directly coupled with/to” or “directly connected to” another element (e.g., a second element), it should be understood that there are no intervening element (e.g., a third element).

According to the situation, the expression “configured to” used in this disclosure may be used as, for example, the expression “suitable for”, “having the capacity to”, “designed to”, “adapted to”, “made to”, or “capable of”. The term “configured to” must not mean only “specifically designed to” in hardware. Instead, the expression “a device configured to” may mean that the device is “capable of” operating together with another device or other components. For example, a “processor configured to (or set to) perform A, B, and C” may mean a dedicated processor (e.g., an embedded processor) for performing a corresponding operation or a generic-purpose processor (e.g., a central processing unit (CPU) or an application processor (AP)) which performs corresponding operations by executing one or more software programs which are stored in a memory device.

All the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal unless expressly so defined in various embodiments of this disclosure. In some cases, even if terms are terms which are defined in this disclosure, they may not be interpreted to exclude various embodiments of this disclosure.

An electronic device according to various embodiments of this disclosure may include at least one of, for example, smartphones, tablet personal computers (PCs), mobile phones, video telephones, electronic book readers, desktop PCs, laptop PCs, netbook computers, workstations, servers, personal digital assistants (PDAs), portable multimedia players (PMPs), Motion Picture Experts Group (MPEG-1 or MPEG-2) audio layer 3 (MP3) players, mobile medical devices, cameras, or wearable devices. According to various embodiments, the wearable device may include at least one of an accessory type (e.g., watches, rings, bracelets, anklets, necklaces, glasses, contact lens, or head-mounted-devices (HMDs), a fabric or garment-integrated type (e.g., an electronic apparel), a body-attached type (e.g., a skin pad or tattoos), or a bio-implantable type (e.g., an implantable circuit).

According to various embodiments, the electronic device may be a home appliance. The home appliances may include at least one of, for example, televisions (TVs), digital versatile disc (DVD) players, audios, refrigerators, air conditioners, cleaners, ovens, microwave ovens, washing machines, air cleaners, set-top boxes, home automation control panels, security control panels, TV boxes (e.g., Samsung HomeSync™, Apple TV™, or Google TV™), game consoles (e.g., Xbox™ or PlayStation™), electronic dictionaries, electronic keys, camcorders, electronic picture frames, and the like.

According to another embodiment, an electronic device may include at least one of various medical devices (e.g., various portable medical measurement devices (e.g., a blood glucose monitoring device, a heartbeat measuring device, a blood pressure measuring device, a body temperature measuring device, and the like), a magnetic resonance angiography (MRA), a magnetic resonance imaging (MRI), a computed tomography (CT), scanners, and ultrasonic devices), navigation devices, Global Navigation Satellite System (GNSS), event data recorders (EDRs), flight data recorders (FDRs), vehicle infotainment devices, electronic equipment for vessels (e.g., navigation systems and gyrocompasses), avionics, security devices, head units for vehicles, industrial or home robots, automatic teller's machines (ATMs), points of sales (POSs) of stores, or internet of things (e.g., light bulbs, various sensors, electric or gas meters, sprinkler devices, fire alarms, thermostats, street lamps, toasters, exercise equipment, hot water tanks, heaters, boilers, and the like).

According to an embodiment, the electronic device may include at least one of parts of furniture or buildings/structures, electronic boards, electronic signature receiving devices, projectors, or various measuring instruments (e.g., water meters, electricity meters, gas meters, or wave meters, and the like). According to various embodiments, the electronic device may be one of the above-described devices or a combination thereof. An electronic device according to an embodiment may be a flexible electronic device. Furthermore, an electronic device according to an embodiment of this disclosure may not be limited to the above-described electronic devices and may include other electronic devices and new electronic devices according to the development of technologies.

Hereinafter, electronic devices according to various embodiments will be described with reference to the accompanying drawings. In this disclosure, the term “user” may refer to a person who uses an electronic device or may refer to a device (e.g., an artificial intelligence electronic device) that uses the electronic device.

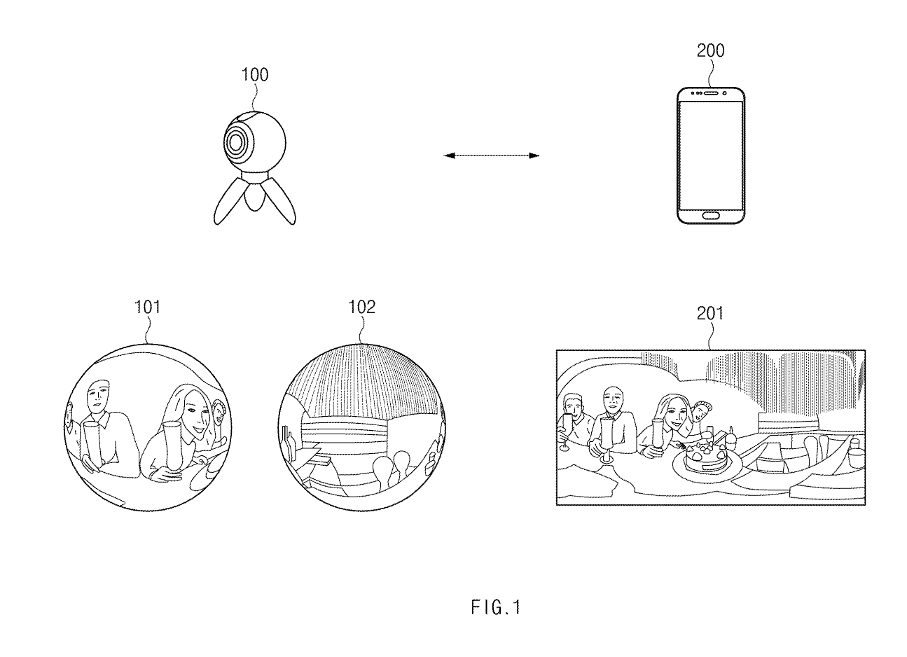

FIG. 1 illustrates an operating environment of a first electronic device an d a second electronic device according to an embodiment of the present disclosure.

Referring to FIG. 1, a first electronic device 100 and a second electronic device 200 according to an embodiment may be operatively connected to each other. For example, the first electronic device 100 and the second electronic device 200 may communicate with each other in a manner such as Wi-Fi, Wi-Fi Direct, Bluetooth (BT), cellular communication, near field communication (NFC), or the like. For another example, the first electronic device 100 and the second electronic device 200 may be wiredly connected to each other through an interface such as a universal serial bus (USB), a D-subminiature (D-sub), a high definition multimedia interface (HDMI), or the like.

The first electronic device 100 according to an embodiment may be a device that captures an image. For example, the first electronic device 100 may be a camera device. Desirably, the first electronic device 100 may be a camera device that is capable of obtaining a multi-view image and includes a plurality of cameras. Each of the plurality of cameras may be a camera including a fisheye lens. The first electronic device 100 may obtain original images by using the plurality of cameras included in the first electronic device 100 and may transmit at least part of the obtained original images to the second electronic device 200. For example, an electronic device may obtain fisheye images, that is, a first image 101 and a second image 102 by using two cameras and may transmit the obtained first image 101 and the obtained second image 102 to the second electronic device 200. Below, an operation of the first electronic device 100 will be exemplified.

The first electronic device 100 may obtain raw data (e.g., Bayer data, RGB data, or YUV data) by using a plurality of cameras. The first electronic device 100 may process and store the raw data in a buffer. The first electronic device 100 may produce a still image or video (for ease of description, the still image or video is referred to as an “image”) by encoding data stored in the buffer. The first electronic device 100 may produce an image in various formats by encoding the data stored in the buffer. For example, the first electronic device 100 may encode video data stored in the buffer in a format such as H.264 (or MPEG-4 Part 10, Advanced Video Coding (MPEG-4 AVC)), third generation partnership project (3GPP), audio video interleaved (AVI), windows media video (WMV), VP9, MPEG-2, Quicktime movie, flash live video (FLV), or the like. For another example, the first electronic device 100 may encode still image data stored in the buffer in a format such as joint photographic experts group (JPEG), bitmap (BMP), tagged image file format (TIFF), portable network graphics (PNG), or the like. For another example, the first electronic device 100 may encode audio data stored in the buffer in a format such as adaptive multi-rate (AMR), Qualcomm code excited linear predictive coding (QCELP), MP3, windows media audio (WMA), advanced audio coding (AAC), free lossless audio codec (FLAC), or the like. The first electronic device 100 may store an image in a memory included in the first electronic device 100 and may also transmit the image to the second electronic device 200 over a network. Also, the first electronic device 100 may produce a preview image by processing an image and may display the preview image in a display included in the first electronic device 100.

The second electronic device 200 according to an embodiment may be a device that receives an image from the first electronic device 100. For example, the second electronic device 200 may be a mobile device such as a smartphone or may be a wearable device such as a head-mounted device or the like. Also, the second electronic device 200 may be one of various computing devices such as a desktop, a laptop computer, and the like. In the case where the first electronic device 100 and the second electronic device 200 are connected to each other, the first electronic device 100 may operate as a sub device, and the second electronic device 200 may operate as a main device. The second electronic device 200 may receive a plurality of images including at least part of each original images from the first electronic device 100. For example, the plurality of images may include at least part of a first original image and at least part of a second original image. The second electronic device 200 may process the plurality of received images. The second electronic device 200 may output a plurality of images. For example, after receiving the first image 101 and the second image 102 from the first electronic device 100, the second electronic device 200 may obtain a third image 201 by stitching the first image 101 and the second image 102 and may output the third image 201. For another example, the second electronic device 200 may obtain the third image 201 from the first electronic device 100. In this case, the first electronic device 100 may stitch the first image 101 and the second image 102. Below, an operation of the second electronic device 200 will be exemplified.

The second electronic device 200 may receive an encoded image or audio over a network from the first electronic device 100 that is operatively connected with the second electronic device 200. The second electronic device 200 may decode the encoded image or audio and may output the decoded image or audio by using a display or audio module. The second electronic device 200 (or the first electronic device 100) may transmit a control signal to the first electronic device 100 (or the second electronic device 200), may control the first electronic device 100 (or the second electronic device 200) for service request, message sending, exchange of status information, and the like, and transmit and receive relevant data.

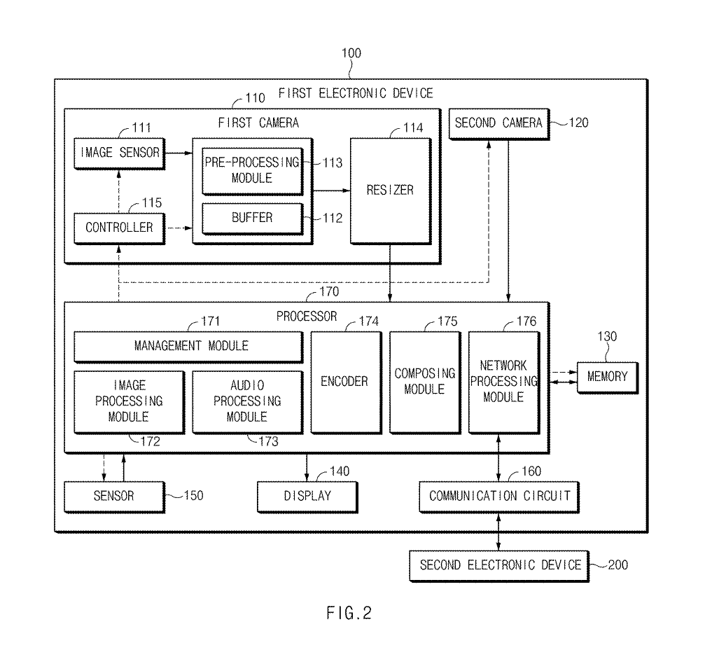

FIG. 2 is a block diagram illustrating a configuration of the first electronic device 100 according to an embodiment of the present disclosure.

Referring to FIG. 2, the first electronic device 100 according to an embodiment may include a first camera 110, a second camera 120, a memory 130, a display 140, and a processor 170. The first electronic device 100 is illustrated in FIG. 2 as including two cameras (the first camera 110 and the second camera 120). However, various embodiments of the present disclosure may not be limited thereto. For example, the first electronic device 100 may include three or more cameras.

The first camera 110 according to an embodiment may include an image sensor 111, a buffer 112, a pre-processing module 113, a resizer 114, and a controller 115 (e.g., at least one processor). The first camera 110 may obtain an image of an external region. The first camera 110 may store raw data produced by the image sensor 111 in the buffer 112. The raw data may be processed by the controller 115 of the first camera 110 or the processor 170, and the processed data may be provided to the display 140 or an encoder 174. Alternatively, the raw data may be processed and stored in the buffer 112 and may be provided from the buffer 112 to the display 140 or the encoder 174. The first camera 110 may include a fisheye lens, and an image obtained by the first camera 110 may be part of an equirectangular (ERP) image, a panorama image, a circular fisheye image, a spherical image, or a three-dimensional (3D) image.

The image sensor 111 may collect raw data by sensing light incident from the outside. For example, the image sensor 111 may include one or more of a charge coupled device (CCD), a complementary metal oxide semiconductor (CMOS) image sensor 111, or an infrared (IR) photo sensor 150. The image sensor 111 may be controlled by the controller 115.

The buffer 112 may store data obtained by the image sensor 111. The buffer 112 may store data obtained by the image sensor 111 without modification; alternatively, after data obtained by the image sensor 111 are processed by the pre-processing module 113, the controller 115, the processor 170, or the like, the buffer 112 may store the processed data. Data stored in the buffer 112 may be provided to and processed by the pre-processing module 113, the controller 115, the processor 170, or the like. Data stored in the buffer 112 may be provided to the display 140 and may be displayed in the display 140. The buffer 112 may have a form of a line array or may be a frame buffer. The buffer 112 may be a ring buffer and may store a plurality of images in a first in, first out (FIFO) manner. A time interval in which images are stored in the buffer 112 or an interval in which images are provided from the buffer 112 to another element may be set by the control signal of the controller 115. For example, vertical blanking intervals and/or a frame rate may be adjusted by the control signal. In the case where the first camera 110 includes a plurality of image sensors and data are provided from the plurality of image sensors to one buffer 112, pieces of data received from the plurality of image sensors 111 may be individually stored or transmitted by adjusting the vertical blanking interval (VBI).

The pre-processing module 113 (e.g., at least one pre-processor) may convert raw data obtained by the image sensor 111 into a color space (e.g., YUV, RGB, or RGBA). The pre-processing module 113 may provide the converted data to the buffer 112 or the processor 170. The pre-processing module 113 may correct an error or distortion of the received image and may adjust a color, a size, or the like of the received image. For example, the pre-processing module 113 may perform bad pixel correction (BPC), lens shading (LS), demosaicing, white balance (WB), gamma correction, color space conversion (CSC), hue, saturation, and contrast (HSC) improvement, size conversion, filtering, and/or image analysis.

According to an embodiment, the pre-processing module 113 may receive the raw data of the first image 101 and the second image 102 illustrated in FIG. 1. The pre-processing module 113 may convert the first image 101 into a rectangular image including a region of the left half of the third image 201 illustrated in FIG. 1 and may convert the second image 102 into a rectangular image including a region of the right half of the third image 201. The pre-processing module 113 may produce the third image 201 by stitching the converted first image and the converted second image. The pre-processing module 113 may analyze overlapping regions (or fields) of images to combine the images and may produce a lookup table to which geometric transformation characteristics are applied based on the analyzed results and characteristics (e.g., locations, directions which cameras faces, depths, white balancing, camera models, color temperatures, and the like) of the first camera 110 and the second camera 120. If similar characteristics are detected upon processing different images later, the pre-processing module 113 may stitch an image by using the lookup table associated with characteristics to reduce computation. Image stitching may be performed by not the pre-processing module 113 but the processor 170 or may be performed by the second electronic device 200.

The resizer 114 may adjust a size or resolution of an image processed by the pre-processing module 113 or an image stored in the buffer 112. For example, the resizer 114 may convert an image into a specified resolution or may convert an image so as to be suitable for a specified resolution by extracting part of the image. The resizer 114 may set a size or resolution of a video, a still image, or a preview image. For example, the resizer 114 may set a size, a resolution, or region of an image to be output to the display 140 and may set or change a resolution or a pixel region of an image to be encoded. The resizer 114 is illustrated in FIG. 2 as being a separate module. However, various embodiments of the present disclosure may not be limited thereto. For example, the resizer 114 may be included in any other element such as the pre-processing module 113 or the like.

The controller 115 may receive a control signal from the pre-processing module 113, the processor 170, or the second electronic device 200. The controller 115 may control other elements 111 to 114 included in the first camera 110 in response to the received control signal. For example, the controller 115 may control the VBI, a frame rate, a zoom level, an exposure level, a focus, and/or lighting. The controller 115 may control on/off of the first camera 110. The controller 115 may control the pre-processing module 113 such that the pre-processing module 113 performs BPC, LS, demosaicing, WB, gamma correction, CSC, HSC improvement, size conversion, filtering, and/or image analysis. According to an embodiment, the controller 115 may control elements included in the second camera 120 as well as the first camera 110.

The pre-processing module 113 and/or the resizer 114 illustrated in FIG. 2 may be a hardware module or may be a software module executed by any other element such as the controller 115. The image sensor 111, the buffer 112, the pre-processing module 113, the resizer 114, and the controller 115 are illustrated in FIG. 2 as being included in the first camera 110. However, various embodiments of the present disclosure may not be limited thereto. For example, some of the image sensor 111, the buffer 112, the pre-processing module 113, the resizer 114, and the controller 115 may be implemented with separate modules.

The second camera 120 according to an embodiment may be disposed to face a direction different from the first camera 110. The second camera 120 may obtain an image of an external region different from the first camera 110. The second camera 120 may operate at the same time with the first camera 110, or the first camera 110 and the second camera 120 may be operate sequentially. The second camera 120 may operate to be similar to the first camera 110. Although not illustrated in FIG. 2, the second camera 120 may include an element corresponding to the image sensor 111, the buffer 112, the pre-processing module 113, the resizer 114, and/or the controller 115 or may share some of the image sensor 111, the buffer 112, the pre-processing module 113, the resizer 114, and the controller 115 with the first camera 110.

The memory 130 according to an embodiment may store at least part of images obtained by the first camera 110 and the second camera 120. For example, the memory 130 may store images obtained by the first camera 110 and the second camera 120 without modification or may store images processed by the processor 170 or the second electronic device 200.

The display 140 according to an embodiment may output an image. For example, the display 140 may output a still image, a video, or a preview image.

The sensor 150 according to an embodiment may sense a variety of information. For example, the sensor 150 may include a touch sensor, a gyro sensor, a terrestrial magnetism sensor, an acceleration sensor, a biometric sensor, a proximity sensor, an illuminance sensor, and/or a temperature sensor.

A communication circuit 160 (e.g., transceiver) according to an embodiment may communicate with the second electronic device 200. The communication circuit 160 may communicate with a server as well as the second electronic device 200. The communication circuit 160 may transmit and receive data to and from the second electronic device 200 through the server. For example, the communication circuit 160 may include one or more modules, which support various communication manners, such as a cellular module, a Wi-Fi module, a BT module, and/or an NFC module.

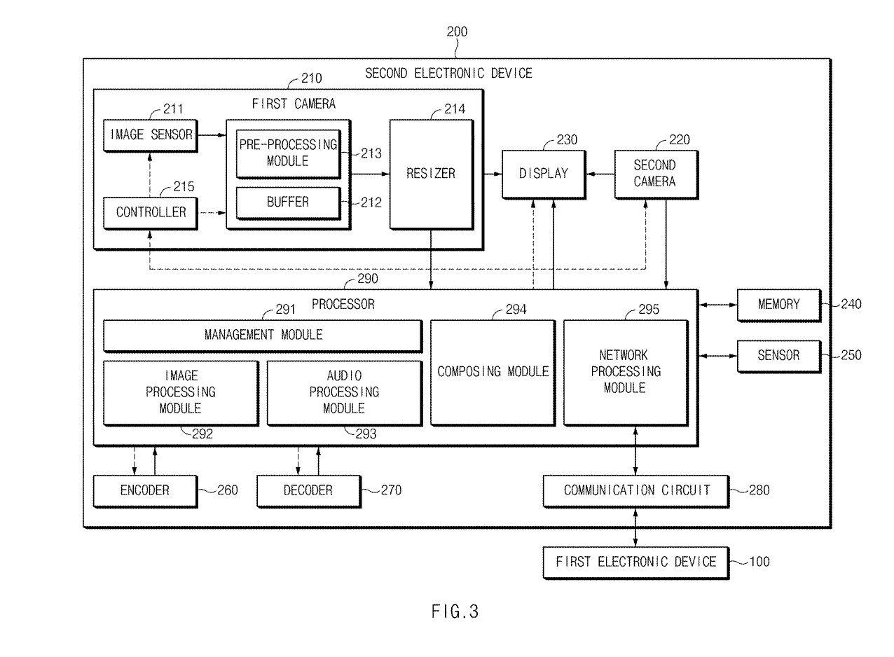

The processor 170 (e.g., at least one processor) according to an embodiment may be electrically connected with the first camera 110, the second camera 120, the memory 130, the display 140, the sensor 150, and the communication circuit 160. The processor 170 may control the first camera 110, the second camera 120, the memory 130, the display 140, the sensor 150, and the communication circuit 160. The processor 170 may include a management module 171, an image processing module 172, an audio processing module 173, the encoder 174, a composing module 175, and a network processing module 176. The management module 171, the image processing module 172, the audio processing module 173, the encoder 174, the composing module 175, and the network processing module 176 may be hardware modules included in the processor 170 or may be software modules executed by the processor 170. The management module 171, the image processing module 172, the audio processing module 173, the encoder 174, the composing module 175, and the network processing module 176 are illustrated in FIG. 2 as being included in the processor 170. However, various embodiments of the present disclosure may not be limited thereto. For example, at least some of the management module 171, the image processing module 172, the audio processing module 173, the encoder 174, the composing module 175, and the network processing module 176 may be implemented with separate modules. The management module 171, the image processing module 172, the audio processing module 173, the encoder 174, the composing module 175, and the network processing module 176 illustrated in FIG. 2 may be implemented to be similar to a management module 291, an image processing module 292, an audio processing module 293 (e.g., audio processor), an encoder 260, a composing module 294, and a network processing module 295 illustrated in FIG. 3. Descriptions of the management module 171, the image processing module 172, the audio processing module 173, the encoder 174, the composing module 175, and the network processing module 176 illustrated in FIG. 2 may be replaced with descriptions of the management module 291, the image processing module 292, the audio processing module 293, the encoder 260, the composing module 294, and the network processing module 295 illustrated in FIG. 3.

According to an embodiment, the processor 170 may obtain a plurality of images (original images) by using a plurality of cameras, respectively. For example, the processor 170 may obtain a first image (e.g., the first image 101 of FIG. 1) by using the first camera 110 and may obtain a second image (e.g., the second image 102 of FIG. 1) by using the second camera 120. The processor 170 may obtain a first image and a second image that are respectively pre-processed by the first camera 110 and the second camera 120.

According to an embodiment, the processor 170 may obtain information, which is associated with the first electronic device 100, the second electronic device 200, or a plurality of images, from the second electronic device 200 or within the first electronic device 100. For example, the processor 170 may obtain information associated with a heating state, a battery level, the amount of power consumption, and/or a network connection state of the first electronic device 100. For another example, the processor 170 may obtain information associated with information of a resource (e.g., a memory, a processor, a camera, a network, an application, or an image processing capability), a heating state, a battery level, the amount of power consumption, and/or a network connection state of the second electronic device 200 from the second electronic device 200. For another example, the processor 170 may obtain information associated with specifications such as resolutions and/or sizes of the first image and the second image.

According to an embodiment, on the basis of information associated with the first electronic device 100, the second electronic device 200, or a plurality of images, the processor 170 may perform at least part of processing for the plurality of images on part of each of the plurality of images or may perform part of processing on the plurality of images. For example, the processor 170 may perform part of processing on part of a plurality of images, may perform part of processing on all the images, or may perform all processes on part of the plurality of images. The processes may include one or more of pre-processing, alignment, warping, blending, encoding, composing, or transmission of a plurality of images. The processor 170 may determine part, on which processing is to be performed in the first electronic device 100, of each of a plurality of images based on information associated with the first electronic device 100, the second electronic device 200, or the plurality of images and may determine a process, which is to be performed in the first electronic device 100, of processes such as pre-processing, alignment, warping, blending, encoding, composing, and the like.

For example, in the case where a state of the first electronic device 100 is inappropriate to process an image (e.g., in the case where a temperature of the first electronic device 100 is higher than a specified value, in the case where a temperature of the first electronic device 100 is not less than a temperature, at which there is a concern about a low-temperature burn, during a specified time or more, in the case where a battery level of the first electronic device 100 is lower than a specified value, or in the case where the amount of power consumption of the first electronic device 100 is larger than a specified value), the processor 170 may perform processing on part (e.g., a central region of each of the plurality of images), which needs relatively small computation for processing, of each of the plurality of images. In this case, the processor 170 may transmit part (e.g., a peripheral region of each of the plurality of images), which needs relatively much computation for processing, to the second electronic device 200 such that the second electronic device 200 processes the part needing relatively much computation for processing.

According to an embodiment, the processor 170 may perform processing by using a parameter received from the second electronic device 200. For example, the processor 170 may transmit at least part (e.g., a peripheral region of each of a plurality of images) of each of a plurality of images to the second electronic device 200. The second electronic device 200 may perform feature extraction from a received image and/or matching of the received image. The second electronic device 200 may calculate a parameter for alignment of an image. The processor 170 may receive a parameter from the second electronic device 200. The processor 170 may process (e.g., stitch) a plurality of images by applying the received parameter to the plurality of images.

For another example, in the case where a state of the first electronic device 100 is inappropriate to process an image, the processor 170 may perform only a process, which needs relatively small computation, on a plurality of images. In this case, after performing the above-described process, the processor 170 may transmit the plurality of images to the second electronic device 200 such that the second electronic device 200 performs processes (e.g., stitching, encoding, and composing) needing relatively much computation.

For another example, since transmission of images to the second electronic device 200 is difficult in the case where a network connection state is bad, the processor 170 may perform most processes on most images. For another example, since computation for processing of an image is much in the case where a resolution of the image is high, the processor 170 may transmit the image to the second electronic device 200 such that the second electronic device 200 performs most processes on most of the image.

According to an embodiment, after stitching a plurality of images based on information associated with the first electronic device 100, the second electronic device 200, or a plurality of images, the processor 170 may transmit the stitched image to the second electronic device 200, or the processor 170 may transmit raw data of the plurality of images to the second electronic device 200. For example, in the case where a temperature of the first electronic device 100 is not less than 40° C. and a battery level is not less than 25%, the processor 170 may stitch a plurality of images and may transmit the stitched image to the second electronic device 200. For another example, in the case where a temperature of the first electronic device 100 exceeds 40° C., a battery level is less than 15%, and a resolution of an image is not more than a full high definition (FHD), the processor 170 may transmit raw data of a plurality of images to the second electronic device 200.

According to an embodiment, on the basis of information associated with the first electronic device 100, the second electronic device 200, or a plurality of images, the processor 170 may stitch and store the plurality of images or may individually store the plurality of images. For example, in the case where a temperature of the first electronic device 100 exceeds 40° C., a battery level is less than 15%, and a resolution of an image is less than full high definition (FHD), the processor 170 may stitch a plurality of images and may store the stitched image. For another example, in the case where a temperature of the first electronic device 100 exceeds 60° C. and a battery level is less than 5%, the processor 170 may individually store a plurality of images.

According to an embodiment, the processor 170 may determine whether to perform processing on a plurality of images based on information sensed by an electronic device. For example, if the approach of an external object is sensed by the sensor 150, the processor 170 may stop processing associated with a plurality of images. If an external object approaches the first electronic device 100, a camera may be covered with the external object, and thus, the user may fail to obtain a necessary image. In this case, the processor 170 may interrupt processing associated with a plurality of images such that unnecessary operations are not performed. For another example, in the case where a variation in an image over time is smaller than a specified value, the processor 170 may interrupt processing associated with a plurality of images.

According to an embodiment, to prevent an increase in a temperature of the first electronic device 100, if a temperature of a housing of the first electronic device 100 is not less than 45° C. during one hour or more, is not less than 50° C. during 3 minutes or more, or is not less than 60° C. during 8 seconds or more, the processor 170 may perform processing on a plurality of images such that throughput of the first electronic device 100 decreases. As such, it may be possible to prevent an accident (e.g., preventing of a low-temperature burn) due to an increase in a temperature of the first electronic device 100.

FIG. 3 is a block diagram illustrating a configuration of the second electronic device according to an embodiment of the present disclosure.

Referring to FIG. 3, the second electronic device 200 according to an embodiment may include a first camera 210, a second camera 220, a display 230, a memory 240, a sensor 250, the encoder 260, a decoder 270, a communication circuit 280 (e.g., transceiver), and a processor 290 (e.g., at least one processor).

The first camera 210 according to an embodiment may include an image sensor 211, a buffer 212, a pre-processing module 213, a resizer 214, and a controller 215. The first camera 210 may obtain an image of an external region. For example, the first camera 210 may be disposed on a rear surface of the second electronic device 200. The image sensor 211, the buffer 212, the pre-processing module 213, the resizer 214, and the controller 215 of the first camera 210 may be implemented to be similar to the image sensor 111, the buffer 112, the pre-processing module 113, the resizer 114, and the controller 115 of the first camera 110 illustrated in FIG. 2.

The second camera 220 according to an embodiment may obtain an image of an external region. For example, in the case where the first camera 210 is disposed on a rear surface of the second electronic device 200, the second camera 220 may be disposed on a front surface of the second electronic device 200. The second camera 220 may operate to be similar to the first camera 210. Although not illustrated in FIG. 3, the second camera 220 may include an element corresponding to the image sensor 211, the buffer 212, the pre-processing module 213, the resizer 214, and/or the controller 215 of the first camera 210 or may share some of the image sensor 211, the buffer 212, the pre-processing module 213, the resizer 214, and the controller 215 with the first camera 210.

The second electronic device 200 is illustrated in FIG. 3 as including the first camera 210 and the second camera 220. However, various embodiments of the present disclosure may not be limited thereto. For example, the second electronic device 200 may not include the first camera 210 and the second camera 220.

The display 230 according to an embodiment may output an image. For example, the display 230 may output an image obtained by the first camera 210 or the second camera 220. For another example, the display 230 may output an image (e.g., a still image, a video, or a preview image) received from the first electronic device 100.

The memory 240 according to an embodiment may store at least part of images obtained by the first camera 210 and the second camera 220. The memory 240 may store images obtained by the first electronic device 100. For example, the memory 240 may store the obtained images without modification or may store images processed by the processor 290.

The sensor 250 according to an embodiment may sense a variety of information. For example, the sensor 250 may include a touch sensor, a gyro sensor, a terrestrial magnetism sensor, an acceleration sensor, a biometric sensor, a proximity sensor, an illuminance sensor, and/or a temperature sensor.

The encoder 260 according to an embodiment may encode images obtained by the first camera 210 and the second camera 220. The encoder 260 may encode images obtained from the first electronic device 100. The encoder 260 may encode the obtained images in a video format such as H.264, 3gpp, AVI, WMV, VP9, MPEG2, Quicktime movie, FLV, or the like or may encode the obtained images in a still image format such as JPEG, BMP, TIFF, PNG, or the like.

The decoder 270 according to an embodiment may decode an encoded image. The decoder 270 may decode an image encoded by the encoder 260 or may decode an image obtained from the first electronic device 100.

The encoder 260 and the decoder 270 illustrated in FIG. 3 may be hardware modules or may be software modules executed by the processor 290. The encoder 260 and the decoder 270 are illustrated in FIG. 3 as being separate modules. However, various embodiments of the present disclosure may not be limited thereto. For example, the encoder 260 and the decoder 270 may be implemented with a module included in the processor 290.

The communication circuit 280 according to an embodiment may communicate with the first electronic device 100. The communication circuit 280 may communicate with a server as well as the first electronic device 100. The communication circuit 280 may transmit and receive data to and from the first electronic device 100 through the server. For example, the communication circuit 280 may include one or more modules, which support various communication manners, such as a cellular module, a Wi-Fi module, a BT module, and/or an NFC module. The communication circuit 280 may receive a plurality of images, which correspond to at least part of original images respectively obtained by a plurality of cameras (e.g., the first camera 110 and the second camera 120 of FIG. 1), from the first electronic device 100 including the plurality of cameras.

The processor 290 according to an embodiment may be electrically connected with the first camera 210, the second camera 220, the display 230, the memory 240, the sensor 250, the encoder 260, the decoder 270, and the communication circuit 280. The processor 290 may control first camera 210, the second camera 220, the display 230, the memory 240, the sensor 250, the encoder 260, the decoder 270, and the communication circuit 280. The processor 290 may transmit a control signal to the first electronic device 100 through the communication circuit 280 to control the first electronic device 100. The processor 290 may collect, process, or store an image or may transmit the control signal. For example, the processor 290 may receive an image from the first electronic device 100, may perform a specific process on the received image, and may provide the processed image to the encoder 260. The processor 290 may receive an encoded image and may output the encoded image to the display 230 or may transmit the encoded image to the first electronic device 100 through the communication circuit 280. The processor 290 may decode an encoded image received through the communication circuit 280 from the first electronic device 100 by using the decoder 270 and may output the decoded image to the display 230.

The processor 290 according to an embodiment may include the management module 291, the image processing module 292, the audio processing module 293, the composing module 294, and the network processing module 295. The management module 291, the image processing module 292, the audio processing module 293, the composing module 294, and the network processing module 295 illustrated in FIG. 3 may be hardware modules included in the processor 290 or may be software modules executed by the processor 290. The management module 291, the image processing module 292, the audio processing module 293, the composing module 294, and the network processing module 295 are illustrated in FIG. 3 as being included in the processor 290. However, various embodiments of the present disclosure may not be limited thereto. For example, at least some of the management module 291, the image processing module 292, the audio processing module 293, the composing module 294, and the network processing module 295 may be implemented with separate modules.

The management module 291 may control the image processing module 292, the audio processing module 293, the composing module 294, and the network processing module 295. For example, the management module 291 may control various functions (instruction exchange with an application, a data transmit/receive control through a network, or image processing) for processing images.

According to an embodiment, the management module 291 may control a plurality of cameras (e.g., the first camera 110 and the second camera 120) included in the first electronic device 100. The management module 291 may transmit a control signal to the first electronic device 100 to control the first electronic device 100 such that the first electronic device 100 performs camera initialization, camera power mode control, camera function control, processing (e.g., image search in the buffer 212, VBI control, or the like) of the buffer 212, captured image processing, size control, pause or resume of a camera function, and the like. The management module 291 may control the first electronic device 100 such that the first electronic device 100 adjusts auto-focusing, auto-exposure, a resolution, a bit rate, a frame rate, a camera power mode, VBI, zoom, gamma, white balance (WB), or the like. The management module 291 may provide an obtained image to the image processing module 292 and the audio processing module 293 and may control the image processing module 292 and the audio processing module 293 to perform processing. The management module 291 may provide the obtained image to the encoder 260 and may control the encoder 260 so as to encode the image. The management module 291 may control the network processing module 295 (or the communication circuit 280) such that an image is transmitted to the first electronic device 100 through the communication circuit 280. The management module 291 may control the decoder 270 so as to decode an encoded image. The management module 291 may provide a plurality of images to the composing mode 294 and may control the composing mode 294 so as to compose the plurality of images. The management module 291 may control any other elements based on one or more of pieces of information associated with the first electronic device 100, the second electronic device 200, or an image. The information associated with the first electronic device 100, the second electronic device 200, or the image may be obtained from the first camera 210, the second camera 220, the memory 240, the sensor 250, or the first electronic device 100. For example, the management module 291 may obtain information associated with a resource, a heating state, a battery level, the amount of power consumption, a network connection state, or specifications of an image and may control any other elements based on the obtained information.

The image processing module 292 may perform image processing, noise reduction, filtering, image synthesize, color correction, color conversion, image transformation, 3D modeling, image drawing, augmented reality (AR)/virtual reality (VR) processing, dynamic range adjusting, perspective adjusting, shearing, resizing, edge extraction, region of interest (ROI) determining, image matching, and/or image segmentation. The image processing module 292 may perform processing such as synthesizing of a plurality of images, creating of a stereoscopic image, or creating of a depth-based panorama image, or the like.

The audio processing module 293 may receive audio from a microphone or the first electronic device 100. The audio processing module 293 may perform noise reduction, sound effect applying, sound pressure adjusting, sound field adjusting, equalizer adjusting, or the like.

The composing module 294 may compose images. The composing module 294 may perform image composing, transparency processing, image layer processing, audio mixing, audio and video multiplexing, audio pass processing, or the like. The composing module 294 may stitch a plurality of images. For example, the composing module 294 may stitch images obtained by the first camera 210 and the second camera 220 or may stitch a plurality of images received from the first electronic device 100. The composing module 294 may be included in the image processing module 292 or the audio processing module 293.

The network processing module 295 may establish, maintain, and control a communication session between the first electronic device 100 and the second electronic device 200. The network processing module 295 may support transmitting and receiving of data with an appropriate protocol among various protocols. For example, the network processing module 295 may establish communication so as to communicate with the first electronic device 100 by using one or more of RTP, UDP, TCP, or HTTP. The network processing module 295 may receive data from the first electronic device 100 through the communication circuit 280 and may transmit data to the first electronic device 100.

The network processing module 295 may receive information associated with a status of the first electronic device 100 from the first electronic device 100 and may provide the received information to the management module 291. The management module 291 may determine specifications (e.g., a frame rate, a resolution, a bit rate, a drop rate, VBI, a resizing level, or an encoding bit) of an image based on the received information.

According to an embodiment, the processor 290 may obtain information associated with the first electronic device 100, the second electronic device 200, or a plurality of images. For example, the processor 290 may obtain information associated with a heating state, a battery level, the amount of power consumption, and/or a network connection state of the second electronic device 200. For another example, the processor 290 may receive, from the first electronic device 100, information associated with a heating state, a battery level, the amount of power consumption, and/or a network connection state of the first electronic device 100. For another example, the processor 290 may obtain information associated with specifications such as resolutions and/or sizes of a plurality of images received from the first electronic device 100.

According to an embodiment, on the basis of information associated with the first electronic device 100, the second electronic device 200, or a plurality of images, the processor 290 may perform processing on part of each of the plurality of images or may perform part of processing on the plurality of images. The processes may include two or more of pre-processing, alignment, warping, blending, encoding, composing, or transmission of a plurality of images. For example, the pre-processing may include at least one of processes such as bad pixel correction (BPC), lens shading (LS), demosaicing, white balance (WB), gamma correction, color space conversion (CSC), hue, saturation, and contrast (HSC) improvement, size conversion, filtering, and/or image analysis. The pre-processing may be performed in the pre-processing module 113 or the processor 170 of the first electronic device 100 or may be performed by the processor 290 of the second electronic device 200. The alignment may be a process for arranging a plurality of separated images so as to be continuously located. The warping may be a process for converting a fisheye image (e.g., the first image 101 and the second image 102 of FIG. 1) into a rectangular shape. The warping may include forward warping or inverse warping. The blending may be a process for correcting overlapping portions between a plurality of images. For example, the blending may be a process for creating a natural image by reducing a difference of portions at which a sudden difference occurs between a plurality of images. The stitching may include two or more of the alignment, the warping, and the blending. The stitching may be a process for creating one image by combining a plurality of images. For example, one image (e.g., the third image 201 of FIG. 1) may be created by stitching overlap regions of two or more images (e.g., the first image 101 and the second image 102 of FIG. 1). The stitched image may be an image mapped to a rectangular shape, a panorama shape, a cylindrical shape, a cuboid shape, an octahedral shape, an icosahedron shape, a truncated pyramid shape, or a spherical shape. The encoding may be a process for reducing a capacity of an image file. The composing may be a process for multiplexing a plurality of image each other or together with audio. The transmission may be a process for transmitting an image to the first electronic device 100 through the communication circuit 280.

According to an embodiment, the processor 290 may perform part of a plurality of processes for a plurality of images based on information associated with the first electronic device 100, the second electronic device 200, or a plurality of images. For example, the processor 290 may select part of a plurality of processes, such as pre-processing, alignment, warping, blending, encoding, composing, or transmission, based on information associated with a resource, a heating state, a battery level, the amount of power consumption, or a network connection state of the first electronic device 100 or the second electronic device 200.

After the remaining processes of the plurality of processes are performed on a plurality of images by the first electronic device 100, the processor 290 may receive the plurality of images from the first electronic device 100 and may perform part of the plurality of processes on the plurality of images. For example, in the case where a state of the first electronic device 100 is inappropriate to process an image, the processor 290 may control the first electronic device 100 so as to perform only a process (e.g., pre-processing or warping) needing relatively small computation. After performing the above-described process, the processor 290 may control the first electronic device 100 so as to transmit the processed images to the second electronic device 200. If images are received, the processor 290 may perform the remaining processes (e.g., stitching, encoding, or composing).

According to an embodiment, the processor 290 may select a partial region, which is to be processed, of each of a plurality of images based on information associated with at least part of the first electronic device 100, the second electronic device 200, or the plurality of images. After processing is performed on the partial region of each of the plurality of images by the first electronic device 100, the processor 290 may receive the remaining region of each of the plurality of image from the first electronic device 100 and may perform processing on the remaining region of each of the plurality of images. For example, in the case where a state of the first electronic device 100 is inappropriate to process an image, the processor 290 may control the first electronic device 100 so as to perform only processing on part (e.g., a central region of each of the plurality of images or ROI), which needs relatively small computation for processing, of each of the plurality of images. After performing processing on the part, the processor 290 may control the first electronic device 100 so as to transmit the processed images to the second electronic device 200. If images are received, the processor 290 may perform processing on the remaining region (e.g., a peripheral region of each of the plurality of images or a region that is not the ROI). For example, in the case where a state of the first electronic device 100 is inappropriate to process an image, the processor 290 may control the first electronic device 100 so as to perform only processing (e.g., pre-processing or warping) on one or more images, which are associated with the ROI, of the plurality of images or a region of an image, which includes the ROI. After performing processing on the part, the processor 290 may control the first electronic device 100 so as to transmit the processed images to the second electronic device 200. If images are received, the processor 290 may perform processing on the remaining part (e.g., an image region that is not the ROI or an image that does not include the ROI).

According to an embodiment, to prevent an increase in a temperature of the first electronic device 100, if a temperature of a housing of the first electronic device 100 is not less than 45° C. during one hour or more, is not less than 50° C. during 3 minutes or more, or is not less than 60° C. during 8 seconds or more, the processor 290 may control the firs electronic device 100 such that throughput of the first electronic device 100 decreases. As such, it may be possible to prevent an accident (e.g., a low-temperature burn) due to an increase in a temperature of the first electronic device 100.

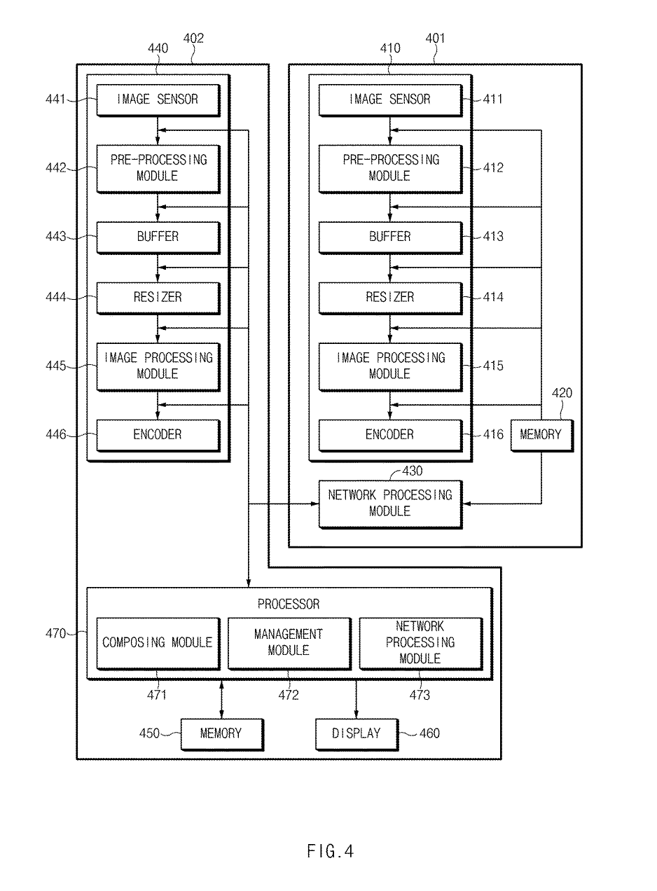

FIG. 4 is a block diagram illustrating a configuration of the first electronic device and the second electronic device according to an embodiment of the present disclosure.

Referring to FIG. 4, a first electronic device 401 and a second electronic device 402 may be operatively connected to each other. The first electronic device 401 may include a camera 410 that include an image sensor 411, a pre-processing module 412, a buffer 413, a resizer 414, an image processing module 415, and an encoder 416, a memory 420, and a network processing module 430. The second electronic device 402 may include a camera 440 that include an image sensor 441, a pre-processing module 442, a buffer 443, a resizer 444, an image processing module 445, and an encoder 446, a memory 450, a display 460, and a processor 470 that includes a composing module 471, a management module 472, and a network processing module 473.

Functions of the image sensor 411, the pre-processing module 412, the buffer 413, the resizer 414, the image processing module 415, and the encoder 416 of the first electronic device 401 may be the same as functions of the image sensor 441, the pre-processing module 442, the buffer 443, the resizer 444, the image processing module 445, and the encoder 446 of the second electronic device 402. Also, although not illustrated in FIG. 4, a processor of the first electronic device 401 and a processor of the second electronic device 402 may perform the same function. Accordingly, processing associated with an image obtained by the first electronic device 401 may be performed by the first electronic device 401 and/or the second electronic device 402 without additional hardware. For example, in the case where a resource of the first electronic device 401 is insufficient, the second electronic device 402 may process an image obtained by the first electronic device 401. For example, after only BPC or LC is performed on raw data obtained in the image sensor 411, the remaining pre-processing such as demosaicing, WB, and the like may be subsequently performed in the pre-processing module 442 included in the second electronic device 402 through the network processing module 430. In this case, the management module 472 may control processing from a next operation by providing the second electronic device 402 with an index indicating that a corresponding image is processed to any operation in the first electronic device 401. As such, a computational burden on the first electronic device 401 may decrease.

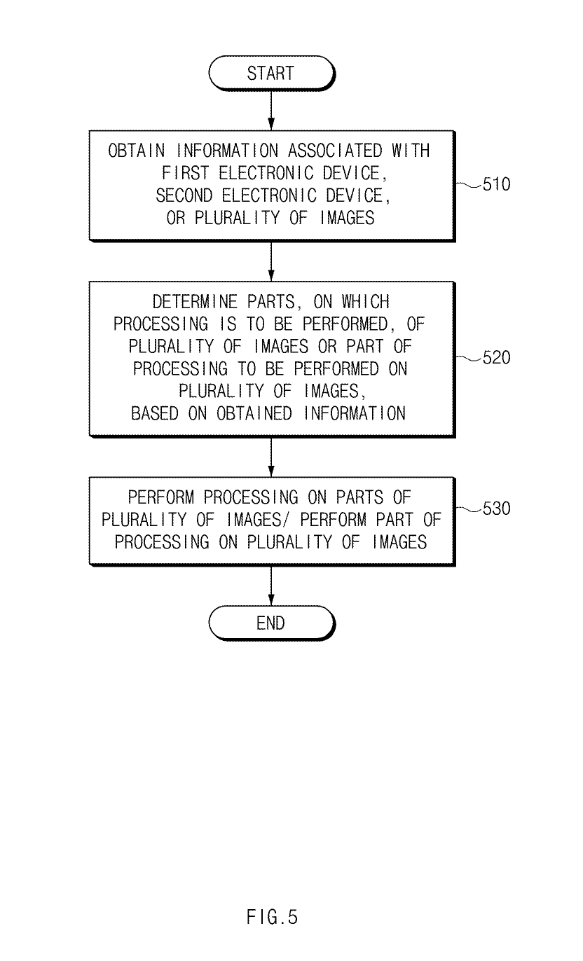

FIG. 5 is a flowchart for describing an image processing method of the second electronic device according to an embodiment of the present disclosure.

The flowchart illustrated in FIG. 5 may include operations processed in the electronic device 200 illustrated in FIGS. 1 to 4. Accordingly, even though omitted below, contents of the second electronic device 200 described with reference to FIGS. 1 to 4 may be applied to the flowchart illustrated in FIG. 5.

Referring to FIG. 5, in operation 510, a second electronic device may obtain information associated with a first electronic device, the second electronic device, or a plurality of images. For example, the second electronic device may obtain information associated with a heating state, a battery level, the amount of power consumption, and/or a network connection state of the first electronic device or the second electronic device or information associated with specifications of a plurality of images obtained by the first electronic device.

In operation 520, based on the obtained information, the second electronic device may determine part, on which processing is to be performed, of each of the plurality of images or part of processing to be performed on the plurality of images. For example, the second electronic device may select a partial region, on which processing is to be performed in the second electronic device, of each of the plurality of images based on information associated with a status of the first electronic device. For another example, the second electronic device may select a process, which is to be performed in the second electronic device, of a plurality of processes based on information associated with resolutions of the plurality of images.

In operation 530, the second electronic device may perform processing on part of each of the plurality of images or may perform part of processing on the plurality of images. For example, in the case where a partial region of each of the plurality of images are selected in operation 520, if the whole or part of each of the plurality of images is received from the first electronic device, the second electronic device may process part selected from each of the plurality of images. For another example, in the case where part of a plurality of processes is selected in operation 520, if the plurality of images d from the first electronic device, the second electronic device may perform part selected from the plurality of processes on the plurality of images.

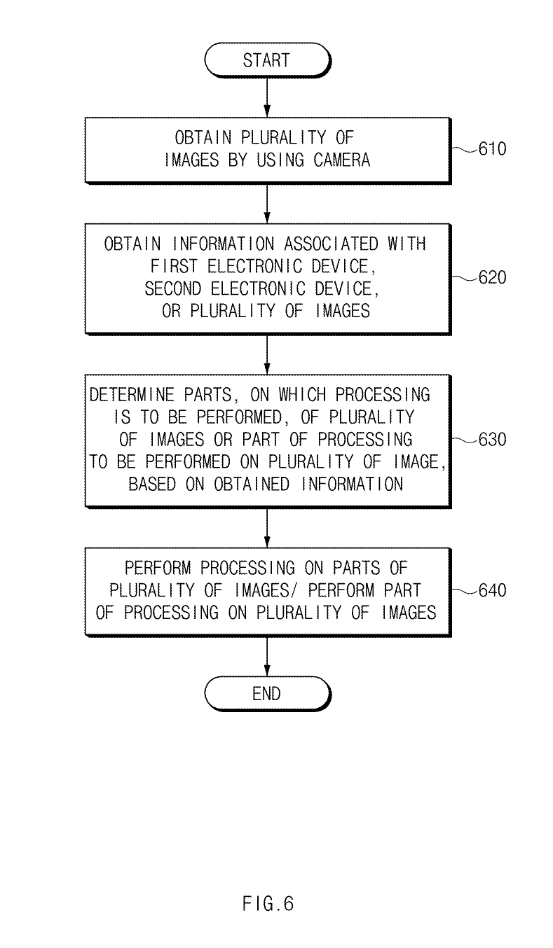

FIG. 6 is a flowchart for describing an image processing method of the first electronic device according to an embodiment of the present disclosure.

The flowchart illustrated in FIG. 6 may include operations processed in the first electronic device 100 illustrated in FIGS. 1 to 4. Accordingly, even though omitted below, contents of the first electronic device 100 described with reference to FIGS. 1 to 4 may be applied to the flowchart illustrated in FIG. 6.

Referring to FIG. 6, in operation 610, a first electronic device may obtain a plurality of images by using a camera. For example, the first electronic device may obtain two fisheye images of opposite directions by using a first camera and a second camera included in the first electronic device.

In operation 620, the first electronic device may obtain information associated with the first electronic device, a second electronic device, or a plurality of images. For example, the first electronic device may obtain information associated with a heating state, a battery level, the amount of power consumption, and/or a network connection state of the first electronic device or the second electronic device or information associated with specifications of a plurality of images obtained by the first electronic device. Operation 620 may be omitted according to implementation of the present disclosure. In this case, the first electronic device may perform operation 630 in response to a command of the second electronic device.

In operation 630, the first electronic device may determine part, on which processing is to be performed, of each of the plurality of images or part of processing to be performed on the plurality of images on the obtained information. For example, the first electronic device may select a partial region, on which processing is to be performed in the first electronic device, of each of the plurality of images based on information associated with a status of the first electronic device. For another example, the first electronic device may select a process, which is to be performed in the first electronic device, of a plurality of processes based on a status of the second electronic device. For another example, the first electronic device may determine part, on which processing is to be performed, of each of the plurality of images or part of processing to be performed on the plurality of images based on a command of the second electronic device.

In operation 640, the first electronic device may perform processing on part of each of the plurality of images or may perform part of processing on the plurality of images. For example, in the case where a partial region of each of the plurality of images is selected in operation 630, the first electronic device may process the remaining part of each of the plurality of images. The first electronic device may transmit the remaining part of each of the plurality of images to the second electronic device. The remaining part of each of the plurality of images may be processed by the second electronic device. For another example, in the case where part of a plurality of processes is selected in operation 630, the first electronic device may perform the selected part of the plurality of processes on the plurality of images. The first electronic device may transmit the plurality of processed images to the second electronic device. The remaining processes of the plurality of processes may be performed by the second electronic device.

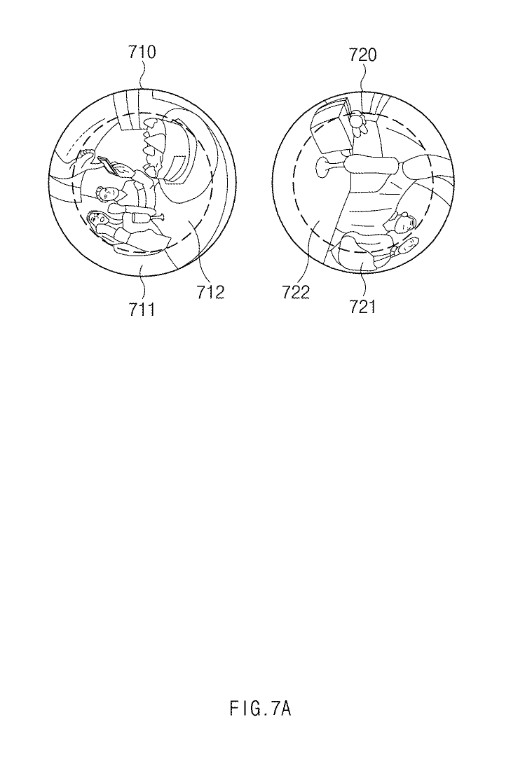

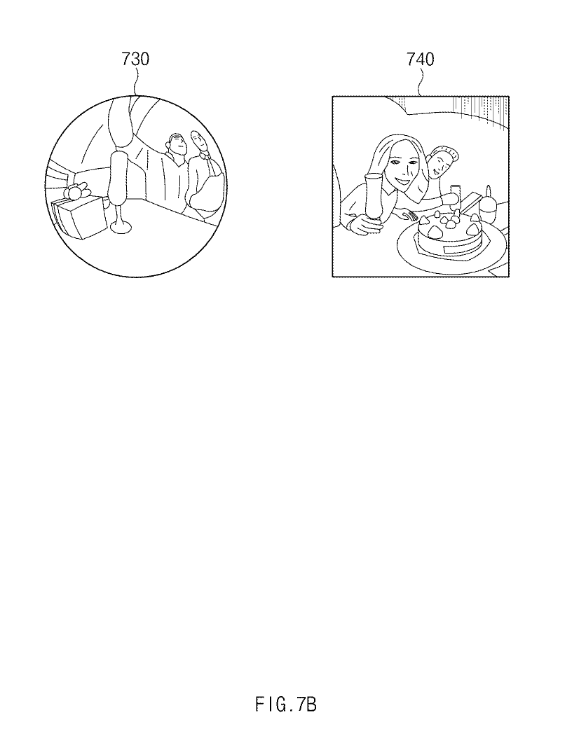

FIGS. 7A and 7B illustrate images obtained by a first electronic device according to various embodiments of the present disclosure.

Referring to FIG. 7A, a first electronic device may obtain a first image 710 and a second image 720. For example, in the case where the first electronic device includes two cameras including a fisheye lens, the first electronic device may obtain two fisheye images as illustrated in FIG. 7A. In the case where an angle of view of a camera included in the first electronic device is 180° or more, a peripheral region 711 of the first image 710 and a peripheral region 721 of the second image 720 may be a region including an image of the same subject. The first image 710 and the second image 720 may be circular. The first image 710 and the second image 720 are illustrated in FIG. 7A as being circular. However, various embodiments of the present disclosure may not be limited thereto. For example, the first image 710 and the second image 720 may be a rectangular shape projected on a rectangular region. The first electronic device may process the first image 710 and the second image 720.

According to an embodiment, the first electronic device may create an omnidirectional image for mapping onto a spherical virtual model by stitching the first image 710 and the second image 720. For example, the omnidirectional image may be a rectangular image or an image for hexahedral mapping. Since computation for creating an omnidirectional image is more complex than any other computation for processing an image, it may burden the first electronic device. Accordingly, to reduce the burden on the first electronic device, part of processing associated with the first image 710 and the second image 720 may be performed by a second electronic device.

According to an embodiment, the second electronic device may obtain part of each of a plurality of images (e.g., the first image 710 and the second image 720) from the first electronic device, may perform processing on the part of each of the plurality of images, and may obtain the remaining part of each of the plurality of images, on which processing is performed, from the first electronic device. The processing associated with the part of each of the plurality of images may need more computation than the processing associated with the remaining part of each of the plurality of images. As such, the second electronic device that has a relatively excellent computation ability compared with the first electronic device may process part needing a lot of computation relatively, thereby reducing the burden on the first electronic device.

In detail, the second electronic device may obtain an image (e.g., the peripheral region 711 or 721) corresponding to a peripheral region (e.g., the peripheral region 711 or 721) of each of the plurality of images (e.g., the first image 710 and the second image 720) from the first electronic device. The second electronic device may perform processing on an image corresponding to the peripheral region. The second electronic device may obtain an image corresponding to a central region (e.g., a central region 721 or 722) other than the peripheral region of each of the plurality of images, on which processing is performed, from the first electronic device. In the case of stitching the first image 710 and the second image 720 to create the omnidirectional image, the peripheral region 711 of the first image 710 and the peripheral region 721 of the second image 720 may be overlapped with each other. A variety of processes, which are associated with the peripheral region 711 of the first image 710 and the peripheral region 721 of the second image 720, such as key point detection (e.g., (scale invariant feature transform (SIFT), (speeded up robust features (SURF)), alignment, blending, or the like) may be required to create the omnidirectional image. Accordingly, in the processing for creating the omnidirectional image, computation needed to process the peripheral regions 711 and 721 of the first and second images 710 and 720 may be more than computation needed to process the central regions 711 and 721 of the first and second images 710 and 720.

According to an embodiment, the first electronic device or the second electronic device may adjust the areas of the peripheral regions 711 and 721 and the central regions 712 and 722 based on similarity between images corresponding to the peripheral regions 711 and 721. For example, in the case where similarity between the peripheral region 711 of the first image 710 and the peripheral region 721 of the second image 720 is high, the areas of the peripheral regions 711 and 721 may be narrowed. For another example, in the case where similarity between the peripheral region 711 of the first image 710 and the peripheral region 721 of the second image 720 is low, the areas of the peripheral regions 711 and 721 may be widened.

According to an embodiment, the first electronic device or the second electronic device may adjust a resolution of images corresponding to the peripheral regions 711 and 721 or a resolution of images corresponding to the central regions 712 and 722 such that the resolution of images corresponding to the peripheral regions 711 and 721 becomes higher than the resolution of images corresponding to the central regions 712 and 722. For example, in the case where stitching is difficult due to a low resolution of the peripheral regions 711 and 721, the first electronic device or the second electronic device may perform processing (e.g., super resolution imaging) for increasing the resolution of the peripheral regions 711 and 721. According to an embodiment, the first electronic device or the second electronic device may adjust frame rates of images corresponding to the peripheral regions 711 and 721 or frame rates of images corresponding to the central regions 712 and 722 such that the frame rates of images corresponding to the peripheral regions 711 and 721 becomes lower than the frame rates of images corresponding to the central regions 712 and 722. For example, in the case where a movement of a camera of the first electronic device or a subject is small, the first electronic device or the second electronic device may decrease a frame rate such that computation is reduced. For example, in the case where a movement of the subject is made in the central regions 712 and 722 and is not made in the peripheral regions 711 and 721, the first electronic device or the second electronic device may decrease the frame rates of the peripheral regions 711 and 721. The first electronic device or the second electronic device may encode an image depending on the adjusted frame rate. For example, the first electronic device or the second electronic device may encode the central regions 712 and 722 at a relatively high frame rate and may encode the peripheral regions 711 and 721 at a relatively low frame rate.

According to an embodiment, the second electronic device may obtain luminance information of an image corresponding to the peripheral region 711 or 721 of each of a plurality of images from the first electronic device. The second electronic device may obtain a parameter for processing based on the luminance information of the image corresponding to the peripheral region 711 or 721. The second electronic device may transmit the parameter to the first electronic device, and the first electronic device may process (stitch) the first image 710 and the second image 720 by using the parameter. The second electronic device may obtain a plurality of processed (stitched) images from the first electronic device.

Referring to FIG. 7B, the first electronic device may obtain a third image 730; at the same time, the second electronic device may obtain a fourth image 740. According to an embodiment, the first electronic device and the second electronic device may process the third image 730 and the fourth image 740. For example, the first electronic device may obtain the third image 730 by using a camera (e.g., the first camera 110 or the second camera 120 of FIG. 2) included in the first electronic device, and the second electronic device may obtain the fourth image 740 by using a camera (e.g., the first camera 210 or the second camera 220 of FIG. 3) included in the second electronic device. The first electronic device may be a camera device, and the second electronic device may be a smartphone. The first electronic device and the second electronic device may operate at the same time. For example, the second electronic device may process part of the third image 730 obtained by the first electronic device after first processing the fourth image 740 obtained by the second electronic device. For example, the second electronic device may perform part of processing associated with the third image 730 after first processing the fourth image 740.

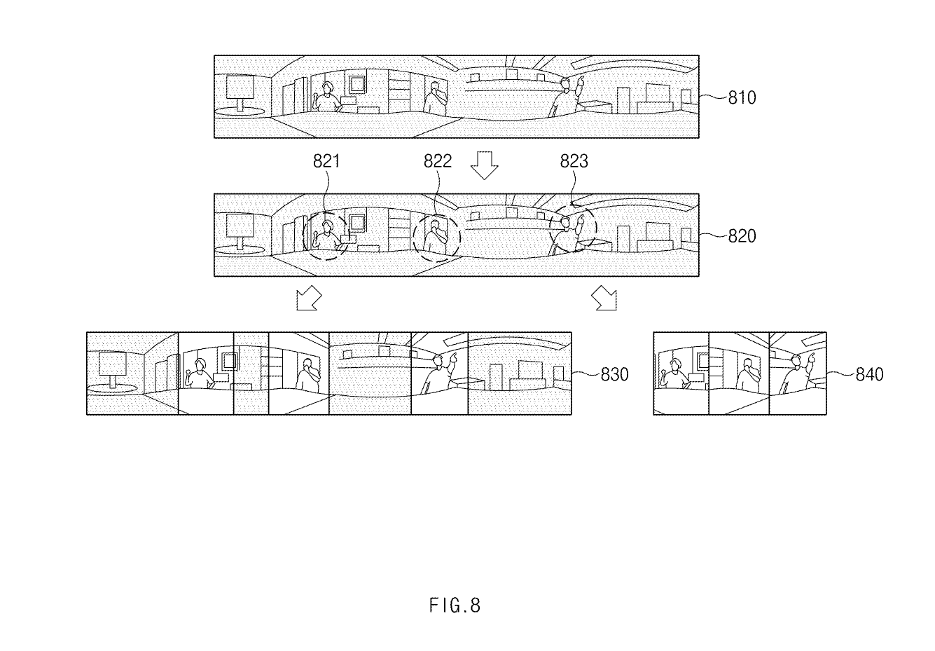

FIG. 8 illustrates an image processed by a first electronic device and the second electronic device according to an embodiment of the present disclosure.

Referring to FIG. 8, a first electronic device may obtain a rectangular image 810 including a plurality of images. The first electronic device may obtain information about a region of interest (ROI) of the rectangular image 810.

According to an embodiment, the first electronic device may obtain information about the ROI from a second electronic device. For example, the ROI may include one or more of a region (e.g., a view port or field of view (FOV)), which is being output in the second electronic device, of an image, a region which is selected by the user in the second electronic device or at which a specified object (e.g., a face of a person, a character(s), a bar code, or the like) is located, or a region including part, in which a change (or a movement of an object) in an image occurs, of a video image received continuously in time. The first electronic device may receive information about the above-described region from the second electronic device as information about the ROI.

According to an embodiment, the first electronic device may determine the ROI by itself. The first electronic device may create information about the ROI based on information sensed in the first electronic device or a plurality of images. The first electronic device may create the information about the ROI. For example, the first electronic device may determine a region, which is being output in the first electronic device, of an image, a region selected by the user in the first electronic device, a region at which a specified object is located, or the like as the ROI. For another example, the first electronic device may determine the ROI based on a direction that a camera faces. For another example, the first electronic device may determine a region including part, in which a change (or a movement of an object) in an image occurs, of a video image that a camera receives continuously in time or an image region corresponding to directivity information of received audio.

The first electronic device may determine a central region of each of a plurality of images obtained by a plurality of cameras as the ROI. In the case where the number of ROIs is “2” or more, the first electronic device may adjust the number of ROIs depending on a resource state of the first electronic device.

According to an embodiment, the first electronic device may determine a candidate region associated with the ROI and may add the candidate region to the ROI. For example, the first electronic device may determine, as a candidate region, another region associated with a current ROI based on motion information of the first electronic device and/or the second electronic device. If a device motion (e.g., a movement of a device by an acceleration sensor, a gyro sensor, a laser, a time of flight (TOF) sensor, or the like) occurs in the first electronic device or the second electronic device, the first electronic device may determine an image region corresponding to a checking direction and a speed of an image associated with the device motion, as a candidate region associated with the ROI. That is, if a device motion of an electronic device due to a head, hand, or body of the user occurs while checking part of a current omnidirectional image, the first electronic device may predict an image region to be displayed later based on a center point and FOV, which vary over time and correspond to the device motion based on a currently set ROI (e.g., an image region being checked) and may determine the predicted image region as a candidate region. For another example, in the case where part of an image is reduced by a zoom out function, the first electronic device may determine up, down, left, and right regions adjacent to the checking region as candidate regions. As the same processing as ROI is performed on a candidate region that is not checked currently, even though an image region checked by a device motion varies, when the user searches for an image through an electronic device, a screen may be changed smoothly, and an image may be expressed without sense of difference.

Returning to FIG. 8, the first electronic device may determine a first region 821, a second region 822, and a third region 823, at which a face of the user is disposed, of the rectangular image 820 as the ROI. The electronic device may process the first region 821, the second region 822, and the third region 823 determined as the ROI to be different from the remaining region.

According to an embodiment, on the basis of information associated with the ROI, the first electronic device may perform processing for the plurality of images on part of each of the plurality of images or may perform part of processing on the plurality of images. For example, the first electronic device may first perform processing on part (e.g., the first region 821, the second region 822, and the third region 823), which corresponds to the ROI, of each of the plurality of images. The first electronic device may create an image 830 by performing a process for improving a resolution on the first region 821, the second region 822, and the third region 823. For another example, the first electronic device may process the first region 821, the second region 822, and the third region 823 in a picture in picture (PiP) or picture by picture (PbP) format. The first electronic device may render the image 840 only including the first region 821, the second region 822, and the third region 823. For another example, the first electronic device may first transmit part, which corresponds to the ROI, of each of the plurality of images to an external device or may process the part corresponding to the ROI with a higher quality (e.g., one or more image quality improvement of a high resolution, expression with the relatively many number of bits for each pixel, focus control, noise reduction, and use of a color quality improvement technique) than any other region. To perform high-quality processing on the first region 821, the second region 822, and the third region 823, the first electronic device may transmit the image 840 including the first region 821, the second region 822, and the third region 823 to the second electronic device and may receive an image 840 of the first region 821, the second region 822, and the third region 823 processed by the second electronic device. The first electronic device may create the image 830 by composing the image 840 processed by the second electronic device and an image including the remaining region. The remaining region may be processed with a relatively lower quality (e.g., use of one or more relatively low image quality improvement techniques of a low resolution, processing pixels with the relatively small number of bits, or use of a relatively low color improvement technique) than the ROI, may be transmitted at a relatively low frequency, may be transmitted after the ROI, or may be transmitted by using a slow communication channel.

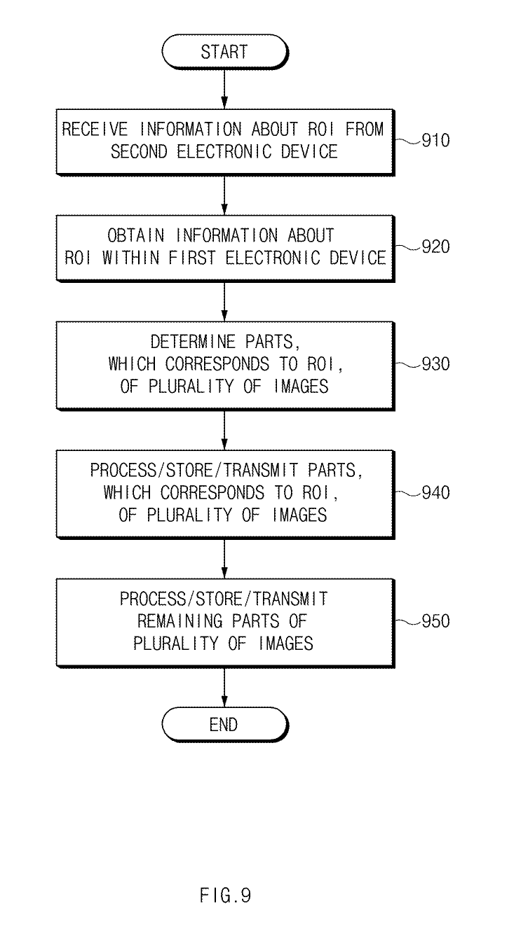

FIG. 9 is a flowchart for describing an image processing method of a first electronic device according to an embodiment of the present disclosure.

The flowchart illustrated in FIG. 9 may include operations processed in the first electronic device 100 illustrated in FIGS. 1 to 4. Accordingly, even though omitted below, contents of the first electronic device 100 described with reference to FIGS. 1 to 4 may be applied to the flowchart illustrated in FIG. 9.

In operation 910, the first electronic device may receive information about an ROI from a second electronic device. For example, the second electronic device may determine a region being output in the second electronic device, a region in which a variation in an image is large, a region in which a face of a specified person is sensed, a region corresponding to a point at which sound is generated, a region selected by the user, or the like as the ROI. The first electronic device may obtain information about the ROI determined as described above, from the second electronic device.

In operation 920, the first electronic device may obtain information about the ROI within the first electronic device. For example, the first electronic device may determine a region being output in the second electronic device, a region in which a variation in an image is large, a region in which a face of a specified person is sensed, a region corresponding to a point at which sound is generated, a region selected by the user, or the like as the ROI. For another example, the first electronic device may determine the ROI based on a movement of the first electronic device. For example, the first electronic device may determine a region corresponding to a direction in which the first electronic device moves, as the ROI.

An embodiment is exemplified in FIG. 9 as operation 910 and operation 920 are all performed sequentially. However, various embodiments of the present disclosure may not be limited thereto. For example, operation 910 and operation 920 may be performed selectively, at the same time, in a reverse sequence.

In operation 930, the first electronic device may determine part, which corresponds to the ROI, of each of the plurality of images. The first electronic device may determine a region, which corresponds to the ROI, of an image based on information about the obtained ROI.

In operation 940, the first electronic device may process, store, and/or transmit the part, which corresponds to the ROI, of each of the plurality of images. For example, the first electronic device may first process the part, which corresponds to the ROI, of each of the plurality of images. For another example, the first electronic device may transmit the part, which corresponds to the ROI, of the plurality of images to the second electronic device. For another example, the first electronic device may process the part corresponding to the ROI with a higher quality (e.g., one or more image quality improvement of a high resolution, expression with the relatively many number of bits for each pixel, focus control, noise reduction, and use of a color quality improvement technique) than the remaining part.

In operation 950, the first electronic device may process, store, and/or transmit the remaining part of each of the plurality of images. For example, the first electronic device may process the remaining part, which does not correspond to the ROI, of each of the plurality of images after the part corresponding to the ROI is processed. In this case, the first electronic device may store the remaining part not corresponding to the ROI and may later process the remaining part. For another example, the first electronic device may transmit the part, which corresponds to the ROI, of each of the plurality of images to the second electronic device and may process the remaining part not corresponding to the ROI by itself. For another example, the first electronic device may process the remaining part not corresponding to the ROI with a relatively lower quality (e.g., use of one or more relatively low image quality improvement techniques of a low resolution, processing pixels with the relatively small number of bits, or use of a relatively low color improvement technique) than the part corresponding to the ROI, may make a transmission frequency relatively low, may transmit the remaining part after the part corresponding to the ROI, or may transmit the remaining part by using a slow communication channel. Operation 940 and operation 950 may include different operations.

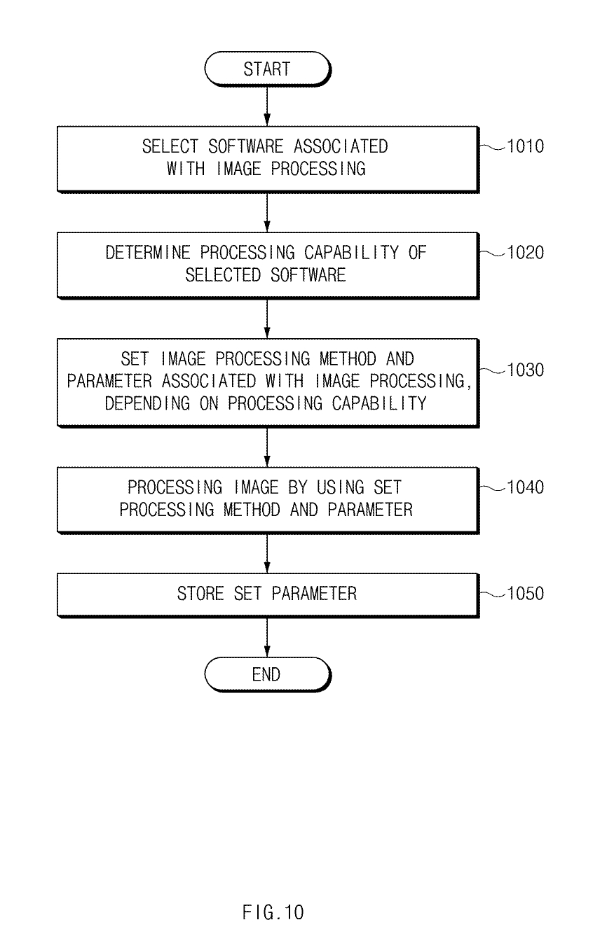

FIG. 10 is a flowchart for describing an image processing method of the first electronic device according to an embodiment of the present disclosure.

The flowchart illustrated in FIG. 10 may include operations processed in the first electronic device 100 illustrated in FIGS. 1 to 4. Accordingly, even though omitted below, contents of the first electronic device 100 described with reference to FIGS. 1 to 4 may be applied to the flowchart illustrated in FIG. 10.

Referring to FIG. 10, in operation 1010, a first electronic device may select software associated with image processing. For example, the first electronic device may select software depending on selection of the user. For another example, the first electronic device may receive information about the selected software from a second electronic device. For another example, the first electronic device may receive a control command, which corresponds to software selected by the user in the second electronic device, from the second electronic device. For example, the software associated with image processing may include a software module associated with a camera for capturing an image, a software module or application for generating an image, an application for display or playing an image, an application for uploading an image, a web service associated with an image, or the like. If the software is selected, the first electronic device may drive a camera included in the first electronic device for image capturing.

In operation 1020, the first electronic device may determine a processing capability of the selected software. For example, in the case where the selected software is software dedicated to a camera included in the first electronic device, it may be determined that a module associated with a supportable image processing capability is mounted. For example, in the case where a camera included in the first electronic device is capable of capturing an omnidirectional image, the first electronic device may determine that a module associated with a supportable image processing capability is mounted, if the selected software is registered as an application capable of supporting the camera. For another example, in the case where the selected software is an application not registered in connection with an omnidirectional image or in the case where the selected software is software registered as a function associated with the omnidirectional image is not supported, the first electronic device may determine that a function associated with the omnidirectional image is not supported.

According to an embodiment, a function associated with the omnidirectional image may be 3D modeling, a projection method, a parameter that a codec or application supports, or the like. The above-described information may be stored in one or more of a video communication management server, a video communication subscriber server, the first electronic device, the second electronic device, or a social network service (SNS) server or may be received from another electronic device. For example, to transmit the above-described information to another electronic device performing image processing or receive the above-described information upon selecting software, the first electronic device may transmit a requirement command to another device.

In operation 1030, the first electronic device may set an image processing method and a parameter associated with image processing depending on a processing capability. For example, the first electronic device may set an image processing method and a parameter corresponding to a selected web service. According to an embodiment, the first electronic device may set the image processing method and the parameter based on information received from another electronic device. For example, the first electronic device may set a region of an image to be transmitted, a resolution, 3D projection-related information, a video duration setting, or a video format.

In operation 1040, the first electronic device may process an image by using the set image processing method and parameter. For example, if a camera-dedicated program for capturing an omnidirectional image is selected, the first electronic device may receive a plurality of images from a camera and may compose the received images by using the selected program. For another example, in the case where the selected program does not support a function associated with the omnidirectional image, the first electronic device may make a request to an external device for image composing, may receive a composed image from the external device, and may output the received image by using the selected software.

In operation 1050, a first electronic device may store the set parameter. For example, the first electronic device may store the set image processing method and parameter after processing an image by using the set image processing method and parameter. The first electronic device may process another image by using the later set image processing method and parameter. For example, in the case of composing a plurality of images obtained by a plurality of cameras included in the first electronic device, the first electronic device may perform geometric mapping between the plurality of images and may generate a parameter (e.g., information of the angle of rotation or shear processing information for an overlapped region) for geometric transformation. The first electronic device may create a geometric transformation look up table (LUT) based on the generated parameter and may store information about a device (e.g., a camera device or a device including a camera device), to which the geometric transformation LUT is applied, together with the LUT. Afterwards, the first electronic device may transform and match a plurality of images by using the LUT.

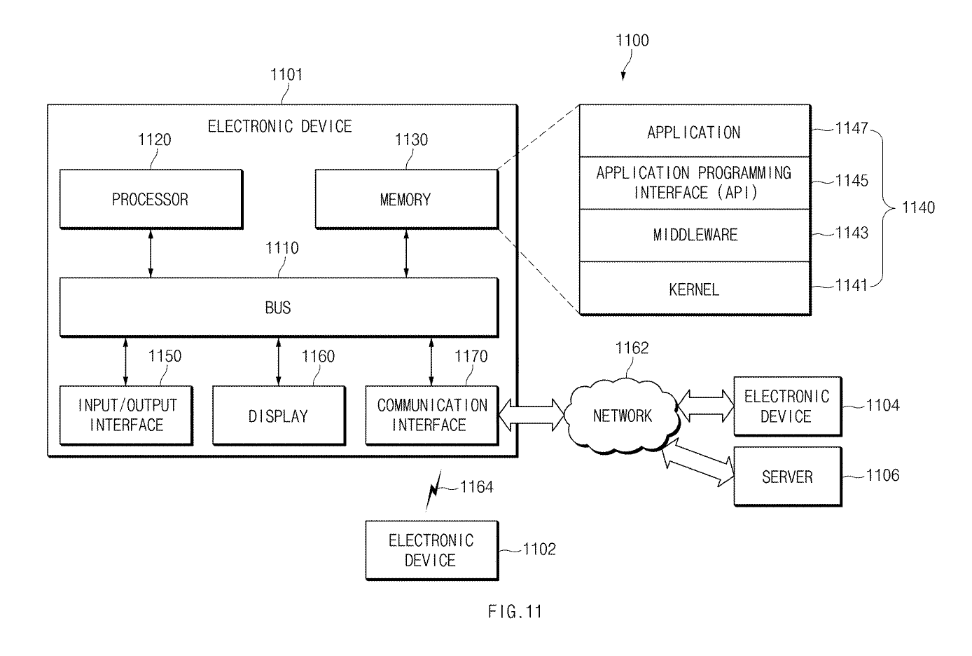

FIG. 11 illustrates an electronic device in a network environment system according to various embodiments of the present disclosure.

Referring to FIG. 11, according to various embodiments, an electronic device 1101, 1102, or 1104, or a server 1106 may be connected each other over a network 1162 or a short range communication 1164. The electronic device 1101 may include a bus 1110, a processor 1120 (e.g., at least one processor), a memory 1130, an input/output interface 1150, a display 1160, and a communication interface 1170 (e.g., a transceiver). According to an embodiment, the electronic device 1101 may not include at least one of the above-described elements or may further include other element(s).

For example, the bus 1110 may interconnect the above-described elements 1120 to 1170 and may include a circuit for conveying communications (e.g., a control message and/or data) among the above-described elements.

The processor 1120 may include one or more of a central processing unit (CPU), an application processor (AP), or a communication processor (CP). For example, the processor 1120 may perform an arithmetic operation or data processing associated with control and/or communication of at least other elements of the electronic device 1101.

The memory 1130 may include a volatile and/or nonvolatile memory. For example, the memory 1130 may store instructions or data associated with at least one other element(s) of the electronic device 1101. According to an embodiment, the memory 1130 may store software and/or a program 1140. The program 1140 may include, for example, a kernel 1141, a middleware 1143, an application programming interface (API) 1145, and/or an application program (or “an application”) 1147. At least a part of the kernel 1141, the middleware 1143, or the API 1145 may be referred to as an “operating system (OS)”.

For example, the kernel 1141 may control or manage system resources (e.g., the bus 1110, the processor 1120, the memory 1130, and the like) that are used to execute operations or functions of other programs (e.g., the middleware 1143, the API 1145, and the application program 1147). Furthermore, the kernel 1141 may provide an interface that allows the middleware 1143, the API 1145, or the application program 1147 to access discrete elements of the electronic device 1101 so as to control or manage system resources.

The middleware 1143 may perform, for example, a mediation role such that the API 1145 or the application program 1147 communicates with the kernel 1141 to exchange data.

Furthermore, the middleware 1143 may process task requests received from the application program 1147 according to a priority. For example, the middleware 1143 may assign the priority, which makes it possible to use a system resource (e.g., the bus 1110, the processor 1120, the memory 1130, or the like) of the electronic device 1101, to at least one of the application program 1147. For example, the middleware 1143 may process the one or more task requests according to the priority assigned to the at least one, which makes it possible to perform scheduling or load balancing on the one or more task requests.

The API 1145 may be, for example, an interface through which the application program 1147 controls a function provided by the kernel 1141 or the middleware 1143, and may include, for example, at least one interface or function (e.g., an instruction) for a file control, a window control, image processing, a character control, or the like.

The input/output interface 1150 may play a role, for example, an interface which transmits an instruction or data input from a user or another external device, to other element(s) of the electronic device 1101. Furthermore, the input/output interface 1150 may output an instruction or data, received from other element(s) of the electronic device 1101, to a user or another external device.

The display 1160 may include, for example, a liquid crystal display (LCD), a light-emitting diode (LED) display, an organic LED (OLED) display, a microelectromechanical systems (MEMS) display, or an electronic paper display. The display 1160 may display, for example, various contents (e.g., a text, an image, a video, an icon, a symbol, and the like) to a user. The display 1160 may include a touch screen and may receive, for example, a touch, gesture, proximity, or hovering input using an electronic pen or a part of a user's body.

For example, the communication interface 1170 may establish communication between the electronic device 1101 and an external device (e.g., the first external electronic device 1102, the second external electronic device 1104, or the server 1106). For example, the communication interface 1170 may be connected to the network 1162 over wireless communication or wired communication to communicate with the external device (e.g., the second external electronic device 1104 or the server 1106).

The wireless communication may use at least one of, for example, long-term evolution (LTE), LTE advanced (LTE-A), code division multiple access (CDMA), wideband CDMA (WCDMA), universal mobile telecommunications system (UMTS), wireless broadband (WiBro), global system for mobile Communications (GSM), or the like, as cellular communication protocol. Furthermore, the wireless communication may include, for example, the short range communication 1164. The short-range communication 1164 may include at least one of Wi-Fi, Bluetooth (BT), near field communication (NFC), magnetic stripe transmission (MST), a global navigation satellite system (GNSS), or the like.

The MST may generate a pulse in response to transmission data using an electromagnetic signal, and the pulse may generate a magnetic field signal. The electronic device 1101 may transfer the magnetic field signal to point of sale (POS), and the POS may detect the magnetic field signal using a Magnetic Secure Transaction (MST) reader. The POS may recover the data by converting the detected magnetic field signal to an electrical signal.

The GNSS may include at least one of, for example, a global positioning system (GPS), a global navigation satellite system (Glonass), a Beidou navigation satellite system (hereinafter referred to as “Beidou”), or a European global satellite-based navigation system (hereinafter referred to as “Galileo”) based on an available region, a bandwidth, or the like. Hereinafter, in this disclosure, “GPS” and “GNSS” may be interchangeably used. The wired communication may include at least one of, for example, a universal serial bus (USB), a high definition multimedia interface (HDMI), a recommended standard-232 (RS-232), a plain old telephone service (POTS), or the like. The network 1162 may include at least one of telecommunications networks, for example, a computer network (e.g., local area network (LAN) or wireless area network (WAN)), an Internet, or a telephone network.

Each of the first and second electronic devices 1102 and 1104 may be a device of which the type is different from or the same as that of the electronic device 1101. According to an embodiment, the server 1106 may include a group of one or more servers. According to various embodiments, all or a portion of operations that the electronic device 1101 will perform may be executed by another or plural electronic devices (e.g., the electronic device 1102, the electronic device 1104 or the server 1106). According to an embodiment, in the case where the electronic device 1101 executes any function or service automatically or in response to a request, the electronic device 1101 may not perform the function or the service internally, but, alternatively additionally, it may request at least a portion of a function associated with the electronic device 1101 at other device (e.g., the electronic device 1102 or 1104 or the server 1106). The other electronic device e.g., the electronic device 1102 or 1104 or the server 1106) may execute the requested function or additional function and may transmit the execution result to the electronic device 1101. The electronic device 1101 may provide the requested function or service using the received result or may additionally process the received result to provide the requested function or service. To this end, for example, cloud computing, distributed computing, or client-server computing may be used.

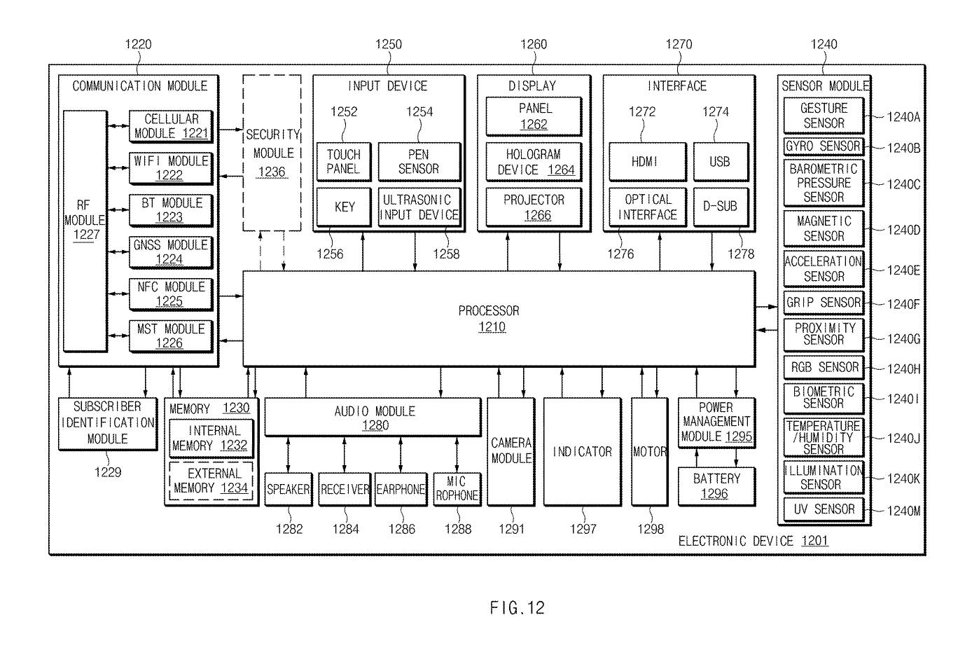

FIG. 12 illustrates a block diagram of an electronic device according to various embodiments of the present disclosure.

Referring to FIG. 12, an electronic device 1201 may include, for example, all or a part of the electronic device 1101 illustrated in FIG. 11. The electronic device 1201 may include one or more processors (e.g., an application processor (AP)) 1210, a communication module 1220, a subscriber identification module (SIM) 1229, a memory 1230, a sensor module 1240, an input device 1250, a display 1260, an interface 1270, an audio module 1280, a camera module 1291, a power management module 1295, a battery 1296, an indicator 1297, and a motor 1298.

The processor 1210 may drive, for example, an operating system (OS) or an application to control a plurality of hardware or software elements connected to the processor 1210 and may process and compute a variety of data. For example, the processor 1210 may be implemented with a system on chip (SoC). According to an embodiment, the processor 1210 may further include a graphic processing unit (GPU) and/or an image signal processor. The processor 1210 may include at least a part (e.g., a cellular module 1221) of elements illustrated in FIG. 12. The processor 1210 may load an instruction or data, which is received from at least one of other elements (e.g., a nonvolatile memory), into a volatile memory and process the loaded instruction or data. The processor 1210 may store a variety of data in the nonvolatile memory.

The communication module 1220 may be configured the same as or similar to the communication interface 1170 of FIG. 11. The communication module 1220 may include the cellular module 1221, a Wi-Fi module 1222, a Bluetooth (BT) module 1223, a GNSS module 1224 (e.g., a GPS module, a Glonass module, a Beidou module, or a Galileo module), a near field communication (NFC) module 1225, a MST module 1226 and a radio frequency (RF) module 1227.

The cellular module 1221 may provide, for example, voice communication, video communication, a character service, an Internet service, or the like over a communication network. According to an embodiment, the cellular module 1221 may perform discrimination and authentication of the electronic device 1201 within a communication network by using the subscriber identification module (SIM) (e.g., a SIM card) 1229. According to an embodiment, the cellular module 1221 may perform at least a portion of functions that the processor 1210 provides. According to an embodiment, the cellular module 1221 may include a communication processor (CP).

Each of the Wi-Fi module 1222, the BT module 1223, the GNSS module 1224, the NFC module 1225, or the MST module 1226 may include a processor for processing data exchanged through a corresponding module, for example. According to an embodiment, at least a part (e.g., two or more) of the cellular module 1221, the Wi-Fi module 1222, the BT module 1223, the GNSS module 1224, the NFC module 1225, and the MST module 1226 may be included within one Integrated Circuit (IC) or an IC package.

For example, the RF module 1227 may transmit and receive a communication signal (e.g., an RF signal). For example, the RF module 1227 may include a transceiver, a power amplifier module (PAM), a frequency filter, a low noise amplifier (LNA), an antenna, or the like. According to another embodiment, at least one of the cellular module 1221, the Wi-Fi module 1222, the BT module 1223, the GNSS module 1224, the NFC module 1225, or the MST module 1226 may transmit and receive an RF signal through a separate RF module.

The subscriber identification module (SIM) 1229 may include, for example, a card and/or embedded SIM that includes a subscriber identification module (SIM) and may include unique identify information (e.g., integrated circuit card identifier (ICCID)) or subscriber information (e.g., integrated mobile subscriber identity (IMSI)).

The memory 1230 (e.g., the memory 1130) may include an internal memory 1232 or an external memory 1234. For example, the internal memory 1232 may include at least one of a volatile memory (e.g., a dynamic random access memory (DRAM), a static RAM (SRAM), a synchronous DRAM (SDRAM), or the like), a nonvolatile memory (e.g., a one-time programmable read only memory (OTPROM), a programmable ROM (PROM), an erasable and programmable ROM (EPROM), an electrically erasable and programmable ROM (EEPROM), a mask ROM, a flash ROM, a flash memory (e.g., a NAND flash memory or a NOR flash memory), or the like), a hard drive, or a solid state drive (SSD).

The external memory 1234 may further include a flash drive such as compact flash (CF), secure digital (SD), micro secure digital (Micro-SD), mini secure digital (Mini-SD), extreme digital (xD), a multimedia card (MMC), a memory stick, or the like. The external memory 1234 may be operatively and/or physically connected to the electronic device 1201 through various interfaces.

A security module 1236 may be a module that includes a storage space of which a security level is higher than that of the memory 1230 and may be a circuit that guarantees safe data storage and a protected execution environment. The security module 1236 may be implemented with a separate circuit and may include a separate processor. For example, the security module 1236 may be in a smart chip or a secure digital (SD) card, which is removable, or may include an embedded secure element (eSE) embedded in a fixed chip of the electronic device 1201. Furthermore, the security module 1236 may operate based on an operating system (OS) that is different from the OS of the electronic device 1201. For example, the security module 1236 may operate based on java card open platform (JCOP) OS.

The sensor module 1240 may measure, for example, a physical quantity or may detect an operation state of the electronic device 1201. The sensor module 1240 may convert the measured or detected information to an electric signal. For example, the sensor module 1240 may include at least one of a gesture sensor 1240A, a gyro sensor 1240B, a barometric pressure sensor 1240C, a magnetic sensor 1240D, an acceleration sensor 1240E, a grip sensor 1240F, the proximity sensor 1240G, a color sensor 1240H (e.g., red, green, blue (RGB) sensor), a biometric sensor 1240I, a temperature/humidity sensor 1240J, an illuminance sensor 1240K, or an ultra-violet (UV) sensor 1240M. Although not illustrated, additionally or generally, the sensor module 1240 may further include, for example, an E-nose sensor, an electromyography (EMG) sensor, an electroencephalogram (EEG) sensor, an electrocardiogram (ECG) sensor, an infrared (IR) sensor, an iris sensor, and/or a fingerprint sensor. The sensor module 1240 may further include a control circuit for controlling at least one or more sensors included therein. According to an embodiment, the electronic device 1201 may further include a processor that is a part of the processor 1210 or independent of the processor 1210 and is configured to control the sensor module 1240. The processor may control the sensor module 1240 while the processor 1210 remains at a sleep state.

The input device 1250 may include, for example, a touch panel 1252, a (digital) pen sensor 1254, a key 1256, or an ultrasonic input device 1258. For example, the touch panel 1252 may use at least one of capacitive, resistive, infrared and ultrasonic detecting methods. Also, the touch panel 1252 may further include a control circuit. The touch panel 1252 may further include a tactile layer to provide a tactile reaction to a user.

The (digital) pen sensor 1254 may be, for example, a part of a touch panel or may include an additional sheet for recognition. The key 1256 may include, for example, a physical button, an optical key, a keypad, or the like. The ultrasonic input device 1258 may detect (or sense) an ultrasonic signal, which is generated from an input device, through a microphone (e.g., a microphone 1288) and may check data corresponding to the detected ultrasonic signal.

The display 1260 (e.g., the display 1160) may include a panel 1262, a hologram device 1264, or a projector 1266. The panel 1262 may be the same as or similar to the display 1160 illustrated in FIG. 11. The panel 1262 may be implemented, for example, to be flexible, transparent or wearable. The panel 1262 and the touch panel 1252 may be integrated into a single module. The hologram device 1264 may display a stereoscopic image in a space using a light interference phenomenon. The projector 1266 may project light onto a screen so as to display an image. For example, the screen may be arranged in the inside or the outside of the electronic device 1201. According to an embodiment, the display 1260 may further include a control circuit for controlling the panel 1262, the hologram device 1264, or the projector 1266.

The interface 1270 may include, for example, a high-definition multimedia interface (HDMI) 1272, a universal serial bus (USB) 1274, an optical interface 1276, or a D-subminiature (D-sub) 1278. The interface 1270 may be included, for example, in the communication interface 1170 illustrated in FIG. 11. Additionally or generally, the interface 1270 may include, for example, a mobile high definition link (MHL) interface, a SD card/multi-media card (MMC) interface, or an infrared data association (IrDA) standard interface.

The audio module 1280 may convert a sound and an electric signal in dual directions. At least a part of the audio module 1280 may be included, for example, in the input/output interface 1150 illustrated in FIG. 11. The audio module 1280 may process, for example, sound information that is input or output through a speaker 1282, a receiver 1284, an earphone 1286, or the microphone 1288.

For example, the camera module 1291 may shoot a still image or a video. According to an embodiment, the camera module 1291 may include at least one or more image sensors (e.g., a front sensor or a rear sensor), a lens, an image signal processor (ISP), or a flash (e.g., an LED or a xenon lamp).

The power management module 1295 may manage, for example, power of the electronic device 1201. According to an embodiment, a power management integrated circuit (PMIC), a charger IC, or a battery or fuel gauge may be included in the power management module 1295. The PMIC may have a wired charging method and/or a wireless charging method. The wireless charging method may include, for example, a magnetic resonance method, a magnetic induction method or an electromagnetic method and may further include an additional circuit, for example, a coil loop, a resonant circuit, or a rectifier, and the like. The battery gauge may measure, for example, a remaining capacity of the battery 1296 and a voltage, current or temperature thereof while the battery is charged. The battery 1296 may include, for example, a rechargeable battery and/or a solar battery.

The indicator 1297 may display a specific state of the electronic device 1201 or a part thereof (e.g., the processor 1210), such as a booting state, a message state, a charging state, and the like. The motor 1298 may convert an electrical signal into a mechanical vibration and may generate the following effects: vibration, haptic, and the like. Although not illustrated, a processing device (e.g., a GPU) for supporting a mobile TV may be included in the electronic device 1201. The processing device for supporting the mobile TV may process media data according to the standards of digital multimedia broadcasting (DMB), digital video broadcasting (DVB), MediaFlo™, or the like.

Each of the above-mentioned elements of the electronic device according to various embodiments of the present disclosure may be configured with one or more components, and the names of the elements may be changed according to the type of the electronic device. In various embodiments, the electronic device may include at least one of the above-mentioned elements, and some elements may be omitted or other additional elements may be added. Furthermore, some of the elements of the electronic device according to various embodiments may be combined with each other so as to form one entity, so that the functions of the elements may be performed in the same manner as before the combination.

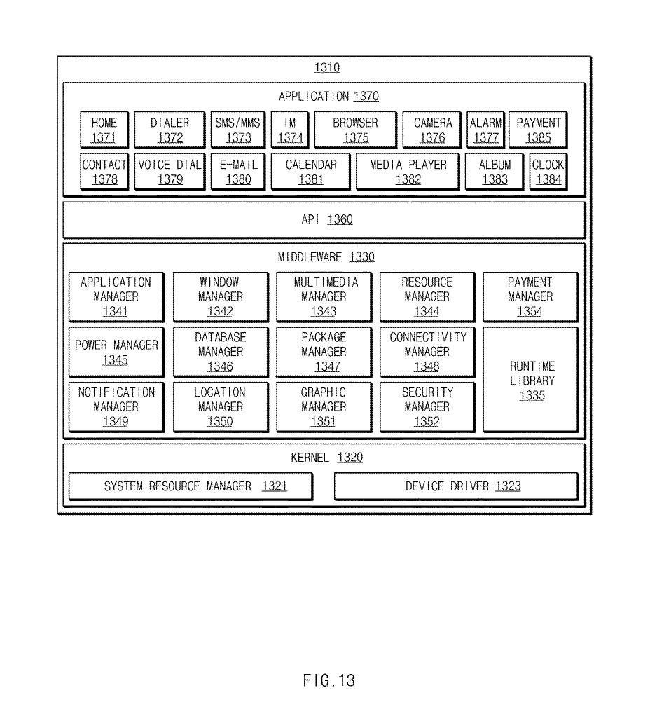

FIG. 13 illustrates a block diagram of a program module according to various embodiments of the present disclosure.

According to an embodiment, a program module 1310 (e.g., the program 1140) may include an operating system (OS) to control resources associated with an electronic device (e.g., the electronic device 1101), and/or diverse applications (e.g., the application program 1147) driven on the OS. The OS may be, for example, Android, iOS, Windows, Symbian, Tizen, or Bada.

The program module 1310 may include a kernel 1320, a middleware 1330, an application programming interface (API) 1360, and/or an application 1370. At least a portion of the program module 1310 may be preloaded on an electronic device or may be downloadable from an external electronic device (e.g., the electronic device 1102 or 1104, the server 1106, or the like).

The kernel 1320 (e.g., the kernel 1141) may include, for example, a system resource manager 1321 or a device driver 1323. The system resource manager 1321 may perform control, allocation, or retrieval of system resources. According to an embodiment, the system resource manager 1321 may include a process managing unit, a memory managing unit, or a file system managing unit. The device driver 1323 may include, for example, a display driver, a camera driver, a Bluetooth driver, a shared memory driver, a USB driver, a keypad driver, a Wi-Fi driver, an audio driver, or an inter-process communication (IPC) driver.

The middleware 1330 may provide, for example, a function that the application 1370 needs in common, or may provide diverse functions to the application 1370 through the API 1360 to allow the application 1370 to efficiently use limited system resources of the electronic device. According to an embodiment, the middleware 1330 (e.g., the middleware 1143) may include at least one of a runtime library 1335, an application manager 1341, a window manager 1342, a multimedia manager 1343, a resource manager 1344, a power manager 1345, a database manager 1346, a package manager 1347, a connectivity manager 1348, a notification manager 1349, a location manager 1350, a graphic manager 1351, a security manager 1352, or a payment manager 1354.

The runtime library 1335 may include, for example, a library module that is used by a compiler to add a new function through a programming language while the application 1370 is being executed. The runtime library 1335 may perform input/output management, memory management, or capacities about arithmetic functions.

The application manager 1341 may manage, for example, a life cycle of at least one application of the application 1370. The window manager 1342 may manage a graphic user interface (GUI) resource that is used in a screen. The multimedia manager 1343 may identify a format necessary for playing diverse media files, and may perform encoding or decoding of media files by using a codec suitable for the format. The resource manager 1344 may manage resources such as a storage space, memory, or source code of at least one application of the application 1370.

The power manager 1345 may operate, for example, with a basic input/output system (BIOS) to manage a battery or power, and may provide power information for an operation of an electronic device. The database manager 1346 may generate, search for, or modify database that is to be used in at least one application of the application 1370. The package manager 1347 may install or update an application that is distributed in the form of package file.

The connectivity manager 1348 may manage, for example, wireless connection such as Wi-Fi or Bluetooth (BT). The notification manager 1349 may display or notify an event such as arrival message, appointment, or proximity notification in a mode that does not disturb a user. The location manager 1350 may manage location information about an electronic device. The graphic manager 1351 may manage a graphic effect that is provided to a user, or manage a user interface relevant thereto. The security manager 1352 may provide a general security function necessary for system security, user authentication, or the like. According to an embodiment, in the case where an electronic device (e.g., the electronic device 1101) includes a telephony function, the middleware 1330 may further include a telephony manager for managing a voice or video call function of the electronic device.

The middleware 1330 may include a middleware module that combines diverse functions of the above-described elements. The middleware 1330 may provide a module specialized to each OS kind to provide differentiated functions. Additionally, the middleware 1330 may dynamically remove a part of the preexisting elements or may add new elements thereto.

The API 1360 (e.g., the API 1145) may be, for example, a set of programming functions and may be provided with a configuration that is variable depending on an OS. For example, in the case where an OS is the Android™ or the iOS™, it may provide one API set per platform. In the case where an OS is Tizen™, it may provide two or more API sets per platform.

The application 1370 (e.g., the application program 1147) may include, for example, one or more applications capable of providing functions for a home 1371, a dialer 1372, an short message service (SMS)/multimedia messaging service (MMS) 1373, an instant message (IM) 1374, a browser 1375, a camera 1376, an alarm 1377, a contact 1378, a voice dial 1379, an e-mail 1380, a calendar 1381, a media player 1382, an album 1383, a timepiece 1384, a payment 1385 or offering of health care (e.g., measuring an exercise quantity, blood sugar, or the like) or environment information (e.g., information of barometric pressure, humidity, temperature, or the like).

According to an embodiment, the application 1370 may include an application (hereinafter referred to as “information exchanging application” for descriptive convenience) to support information exchange between an electronic device (e.g., the electronic device 1101) and an external electronic device (e.g., the electronic device 1102 or 1104). The information exchanging application may include, for example, a notification relay application for transmitting specific information to an external electronic device, or a device management application for managing the external electronic device.

For example, the notification relay application may include a function of transmitting notification information, which arise from other applications (e.g., applications for SMS/MMS, e-mail, health care, or environmental information), to an external electronic device (e.g., the electronic device 1102 or 1104). Additionally, the information exchanging application may receive, for example, notification information from an external electronic device and provide the notification information to a user.

The device management application may manage (e.g., install, delete, or update), for example, at least one function (e.g., turn-on/turn-off of an external electronic device itself (or a part of elements) or adjustment of brightness (or resolution) of a display) of the external electronic device (e.g., the electronic device 1102 or 1104) which communicates with the electronic device, an application running in the external electronic device, or a service (e.g., a call service, a message service, or the like) provided from the external electronic device.

According to an embodiment, the application 1370 may include an application (e.g., a health care application of a mobile medical device) that is assigned in accordance with an attribute of an external electronic device (e.g., the electronic device 1102 or 1104). According to an embodiment, the application 1370 may include an application that is received from an external electronic device (e.g., the electronic device 1102 or 1104, or the server 1106). According to an embodiment, the application 1370 may include a preloaded application or a third party application that is downloadable from a server. The names of elements of the program module 1310 according to the embodiment may be modifiable depending on kinds of operating systems.

According to various embodiments, at least a portion of the program module 1310 may be implemented by software, firmware, hardware, or a combination of two or more thereof. At least a portion of the program module 1310 may be implemented (e.g., executed), for example, by the processor (e.g., the processor 1210). At least a portion of the program module 1310 may include, for example, modules, programs, routines, sets of instructions, processes, or the like for performing one or more functions.

The term “module” used in this disclosure may represent, for example, a unit including one or more combinations of hardware, software and firmware. The term “module” may be interchangeably used with the terms “unit”, “logic”, “logical block”, “component” and “circuit”. The “module” may be a minimum unit of an integrated component or may be a part thereof. The “module” may be a minimum unit for performing one or more functions or a part thereof. The “module” may be implemented mechanically or electronically. For example, the “module” may include at least one of an application-specific IC (ASIC) chip, a field-programmable gate array (FPGA), and a programmable-logic device for performing some operations, which are known or will be developed.

At least a part of an apparatus (e.g., modules or functions thereof) or a method (e.g., operations) according to various embodiments may be, for example, implemented by instructions stored in a computer-readable storage media in the form of a program module. The instruction, when executed by a processor (e.g., the processor 1120), may cause the one or more processors to perform a function corresponding to the instruction. The computer-readable storage media, for example, may be the memory 1130.

A computer-readable recording medium may include a hard disk, a floppy disk, a magnetic media (e.g., a magnetic tape), an optical media (e.g., a compact disc read only memory (CD-ROM) and a digital versatile disc (DVD), a magneto-optical media (e.g., a floptical disk)), and hardware devices (e.g., a read only memory (ROM), a random-access memory (RAM), or a flash memory). Also, a program instruction may include not only a mechanical code such as things generated by a compiler but also a high-level language code executable on a computer using an interpreter. The above hardware unit may be configured to operate via one or more software modules for performing an operation of various embodiments of the present disclosure, and vice versa.

A module or a program module according to various embodiments may include at least one of the above elements, or a part of the above elements may be omitted, or additional other elements may be further included. Operations performed by a module, a program module, or other elements according to various embodiments may be executed sequentially, in parallel, repeatedly, or in a heuristic method. In addition, some operations may be executed in different sequences or may be omitted. Alternatively, other operations may be added.

According to various embodiments disclosed in this disclosure, computation of a capturing device may be reduced by performing processing on part of each of images or part of processing on the images at an electronic device. Besides, a variety of effects directly or indirectly understood through this disclosure may be provided.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An electronic device comprising:
a communication circuit configured to receive a plurality of images including at least a part of original images obtained by a plurality of cameras of an external device;
a memory configured to store the received plurality of images; and
at least one processor electrically connected with the communication circuit and the memory,
wherein the at least one processor is configured to:
obtain information associated with at least part of the external device, the electronic device, or the plurality of images, and
based on the obtained information, at least one of:
perform a plurality of processes on a part of each of the plurality of images, or
perform a part of the plurality of processes on at least part of each of the plurality of images.

2. The electronic device of claim 1, wherein the at least one processor is further configured to:
select the part of the plurality of processes for the plurality of images based on the obtained information associated with the at least part of the external device, the electronic device, or the plurality of images,
receive the at least part of each of the plurality of images from the external device after a remaining part of the plurality of processes is performed on the at least part of each of the plurality of images by the external device, and
perform the part of the plurality of processes on the at least part of each of the plurality of images.

3. The electronic device of claim 2, wherein the plurality of processes includes at least two or more of pre-processing, alignment, warping, blending, encoding, composing, or transmission.

4. The electronic device of claim 1, wherein the at least one processor is further configured to obtain information associated with at least part of a resource, a heating state, a battery level, the amount of power consumption, a network connection state of the electronic device or the external device, or specifications of the plurality of images.

5. The electronic device of claim 1, wherein the at least one processor is further configured to:
obtain a first plurality of images each corresponding to a part of each of the original images from the external device,
perform at least part of the plurality of processes on the first plurality of images, and
obtain a second plurality of images each corresponding to a remaining part of each of the original images from the external device.

6. The electronic device of claim 5, wherein a computation of the at least one processor needed for the plurality of processes on the first plurality of images is greater than a computation needed for the plurality of processes on the second plurality of images.

7. The electronic device of claim 1, wherein the at least one processor is further configured to:
obtain images corresponding to peripheral regions of each of the original images from the external device,
perform at least part of the plurality of the processes on the obtained images corresponding to the peripheral regions, and
obtain images corresponding to central regions of each of the original images, on which the at least part of the plurality of the processes is performed, from the external device.

8. The electronic device of claim 7, wherein the at least one processor is further configured to adjust areas of the peripheral regions and the central regions based on a similarity between the images corresponding to the peripheral regions.

9. The electronic device of claim 7, wherein the at least one processor is further configured to adjust a resolution of the images corresponding to the peripheral regions or a resolution of the images corresponding to the central regions such that the resolution of the images corresponding to the peripheral regions becomes higher than the resolution of the images corresponding to the central regions.

10. The electronic device of claim 7, wherein the at least one processor is further configured to adjust a frame rate of the images corresponding to the peripheral regions or a frame rate of the images corresponding to the central regions such that the frame rate of the images corresponding to the peripheral regions becomes lower than the frame rate of the images corresponding to the central regions.

11. The electronic device of claim 1, wherein the at least one processor is further configured to:
obtain luminance information associated with peripheral regions of each of the original images from the external device,
obtain a parameter for the plurality of the processes based on the luminance information associated with the peripheral regions,
transmit the parameter to the external device, and
obtain the plurality of images processed based on the parameter from the external device.

12. An electronic device comprising:
a plurality of cameras disposed to face different directions;
a communication circuit configured to communicate with an external device; and
at least one processor electrically connected with the plurality of cameras and the communication circuit,
wherein the at least one processor is configured to:
obtain a plurality of images by respectively using the plurality of cameras,
obtain information associated with at least a part of the external device, the electronic device, or the plurality of images, from the external device or within the electronic device, and
based on the obtained information, at least one of:
perform a plurality of processes on a part of each of the plurality of images, or
perform a part of the plurality of processes on at least part of each of the plurality of images.

13. The electronic device of claim 12, wherein the at least one processor is further configured to:
stitch the plurality of images based on the obtained information associated with the at least a part of the external device, the electronic device, or the plurality of images, and
after the stitching, control the communication circuit to one of:
transmit the stitched image to the external device, or
transmit raw data of the plurality of images to the external device.

14. The electronic device of claim 12, further comprising:
a memory electrically connected with the at least one processor,
wherein the at least one processor is further configured to:
stitch the plurality of images based on the information associated with the at least part of the external device, the electronic device, or the plurality of images, and
after the stitching:
store the stitched image in the memory, or
store the plurality of images in the memory individually.

15. The electronic device of claim 12, wherein the at least one processor is further configured to interrupt at least part of the plurality of processes on the at least part of the plurality of images based on information sensed by the electronic device.

16. The electronic device of claim 12, wherein the at least one processor is further configured to:
obtain information about a region of interest (ROI) in the plurality of images, and
based on the information about the ROI, at least one of:
perform the plurality of the processes on the part of each of the plurality of images, or
perform the part of the plurality of processes on the at least part of each of the plurality of images.

17. The electronic device of claim 16, wherein the at least one processor is further configured to receive the information about the ROI from the external device.

18. The electronic device of claim 16, wherein the at least one processor is further configured to generate the information about the ROI based on information sensed in the electronic device or the plurality of images.

19. The electronic device of claim 16, wherein the at least one processor is further configured to perform the plurality of the processes on a part which corresponds to the ROI of the plurality of images.

20. The electronic device of claim 16, wherein the at least one processor is further configured to transmit a part, which corresponds to the ROI of the plurality of images, to the external device.
